(19) United States
(12) Patent Application Publication
(10) Pub. No.: US 2023/0328713 A1
(43) Pub. Date: Oct. 12, 2023

(54) CONFIGURED GRANT (CG) UPLINK CONTROL INFORMATION AND RETRANSMISSIONS FOR NON-CONFIGURATION OF CG RETRANSMISSION TIMER

(71) Applicant: QUALCOMM Incorporated, San Diego, CA (US)

(72) Inventors: Shaozhen GUO, Beijing (CN); Jing SUN, San Diego, CA (US); Changlong XU, Beijing (CN); Xiaoxia ZHANG, San Diego, CA (US); Rajat PRAKASH, San Diego, CA (US); Ozcan OZTURK, San Diego, CA (US)

(21) Appl. No.: 18/044,139

(22) PCT Filed: Oct. 23, 2020
(86) PCT No.: PCT/CN2020/123218

§ 371 Date: Mar. 6, 2023

(51) Int. Cl. H04W 72/1263; H04W 72/21; H04L 1/1812; H04W 74/08

(52) U.S. Cl. CPC H04W 72/1263; H04W 74/0816; H04L 1/1812; H04W 72/21

(57) ABSTRACT

Various aspects of the present disclosure generally relate to wireless communication. In some aspects, a user equipment (UE) may generate configured grant uplink control information (CG-UCI) based at least in part on a determination that a configured grant (CG) retransmission timer is not configured. The UE may transmit the CG-UCI on a physical uplink channel to a base station. In some aspects, the UE may receive a configuration indicating that retransmission on a CG resource is enabled, in association with a determination that a CG retransmission timer is not configured. The UE may transmit a retransmission on the CG resource based at least in part on receiving a message that includes hybrid automatic repeat request feedback for one or more CG communications. Numerous other aspects are provided.

### FIELD OF THE DISCLOSURE

Aspects of the present disclosure generally relate to wireless communication and to techniques and apparatuses for transmission of configured grant (CG) uplink control information or retransmissions if a CG retransmission timer is not configured.

### BACKGROUND

Wireless communication systems are widely deployed to provide various telecommunication services such as telephony, video, data, messaging, and broadcasts. Typical wireless communication systems may employ multiple-access technologies capable of supporting communication with multiple users by sharing available system resources (e.g., bandwidth, transmit power, and/or the like). Examples of such multiple-access technologies include code division multiple access (CDMA) systems, time division multiple access (TDMA) systems, frequency-division multiple access (FDMA) systems, orthogonal frequency-division multiple access (OFDMA) systems, single-carrier frequency-division multiple access (SC-FDMA) systems, time division synchronous code division multiple access (TD-SCDMA) systems, and Long Term Evolution (LTE). LTE/LTE-Advanced is a set of enhancements to the Universal Mobile Telecommunications System (UMTS) mobile standard promulgated by the Third Generation Partnership Project (3 GPP).

A wireless network may include a number of base stations (BSs) that can support communication for a number of user equipment (UEs). A user equipment (UE) may communicate with a base station (BS) via the downlink and uplink. The downlink (or forward link) refers to the communication link from the BS to the UE, and the uplink (or reverse link) refers to the communication link from the UE to the BS. As will be described in more detail herein, a BS may be referred to as a Node B, a gNB, an access point (AP), a radio head, a transmit receive point (TRP), a New Radio (NR) BS, a 5G Node B, and/or the like.

The above multiple access technologies have been adopted in various telecommunication standards to provide a common protocol that enables different user equipment to communicate on a municipal, national, regional, and even global level. New Radio (NR), which may also be referred to as 5G, is a set of enhancements to the LTE mobile standard promulgated by the Third Generation Partnership Project (3GPP). NR is designed to better support mobile broadband Internet access by improving spectral efficiency, lowering costs, improving services, making use of new spectrum, and better integrating with other open standards using orthogonal frequency division multiplexing (OFDM) with a cyclic prefix (CP) (CP-OFDM) on the downlink (DL), using CP-OFDM and/or SC-FDM (e.g., also known as discrete Fourier transform spread OFDM (DFT-s-OFDM)) on the uplink (UL), as well as supporting beamforming, multiple-input multiple-output (MIMO) antenna technology, and carrier aggregation. As the demand for mobile broadband access continues to increase, further improvements in LTE, NR, and other radio access technologies remain useful.

### SUMMARY

In some aspects, a method of wireless communication performed by a user equipment (UE) includes generating configured grant uplink control information (CG-UCI) based at least in part on a determination that a configured grant retransmission timer is not configured, and transmitting the CG-UCI on a physical uplink channel to a base station.

In some aspects, a method of wireless communication performed by a base station includes receiving, from a UE, CG-UCI that is associated with a CG retransmission timer not being configured at the UE, and transmitting an uplink grant, to the UE, that is based at least in part on the CG-UCI.

In some aspects, a method of wireless communication performed by a UE includes receiving a configuration indicating that retransmission on a CG resource is enabled, in association with a determination that a CG retransmission timer is not configured. The method includes receiving a message that includes hybrid automatic repeat request (HARQ) feedback for one or more CG communications, and transmitting a retransmission on the CG resource based at least in part on receiving the message.

In some aspects, a method of wireless communication performed by a base station includes transmitting a configuration, to a UE, indicating that retransmission on a CG resource is enabled, in association with a CG retransmission timer not being configured. The method includes transmitting a message that includes HARQ feedback of one or more CG communications, and receiving a retransmission on the CG resource based at least in part on transmitting the message.

In some aspects, a UE for wireless communication includes a memory and one or more processors operatively coupled to the memory, the memory and the one or more processors configured to generate CG-UCI based at least in part on a determination that a CG retransmission timer is not configured, and transmit the CG-UCI on a physical uplink channel to a base station.

In some aspects, a base station for wireless communication includes a memory and one or more processors operatively coupled to the memory, the memory and the one or more processors configured to receive, from a UE, CG-UCI that is associated with a CG retransmission timer not being configured at the UE, and transmit an uplink grant, to the UE, that is based at least in part on the CG-UCI.

In some aspects, a UE for wireless communication includes a memory and one or more processors operatively coupled to the memory, the memory and the one or more processors configured to receive a configuration indicating that retransmission on a CG resource is enabled, in association with a determination that a CG retransmission timer is not configured, receive a message that includes HARQ feedback for one or more CG communications, and transmit a retransmission on the CG resource based at least in part on receiving the message.

In some aspects, a base station for wireless communication includes a memory; and one or more processors operatively coupled to the memory, the memory and the one or more processors configured to transmit a configuration, to a UE, indicating that retransmission on a CG resource is enabled, in association with a CG retransmission timer not being configured, transmit a message that includes HARQ feedback of one or more CG communications, and receive a retransmission on the CG resource based at least in part on transmitting the message.

In some aspects, a non-transitory computer-readable medium storing a set of instructions for wireless communication includes one or more instructions that, when executed by one or more processors of a UE, cause the UE to generate CG-UCI based at least in part on a determination that a CG retransmission timer is not configured, and transmit the CG-UCI on a physical uplink channel to a base station.

In some aspects, a non-transitory computer-readable medium storing a set of instructions for wireless communication includes one or more instructions that, when executed by one or more processors of a base station, cause the base station to receive, from a UE, CG-UCI that is associated with a CG retransmission timer not being configured at the UE, and transmit an uplink grant, to the UE, that is based at least in part on the CG-UCI.

In some aspects, a non-transitory computer-readable medium storing a set of instructions for wireless communication includes one or more instructions that, when executed by one or more processors of a UE, cause the UE to receive a configuration indicating that retransmission on a CG resource is enabled, in association with a determination that a CG retransmission timer is not configured, receive a message that includes HARQ feedback for one or more CG communications, and transmit a retransmission on the CG resource based at least in part on receiving the message.

In some aspects, a non-transitory computer-readable medium storing a set of instructions for wireless communication includes one or more instructions that, when executed by one or more processors of a base station, cause the base station to transmit a configuration, to a UE, indicating that retransmission on a CG resource is enabled, in association with a CG retransmission timer not being configured, transmit a message that includes HARQ feedback of one or more CG communications, and receive a retransmission on the CG resource based at least in part on transmitting the message.

In some aspects, an apparatus for wireless communication includes means for generating CG-UCI based at least in part on a determination that a CG retransmission timer is not configured, and means for transmitting the CG-UCI on a physical uplink channel to a base station.

In some aspects, an apparatus for wireless communication includes means for receiving, from a UE, CG-UCI that is associated with a CG retransmission timer not being configured at the UE, and means for transmitting an uplink grant, to the UE, that is based at least in part on the CG-UCI.

In some aspects, an apparatus for wireless communication includes means for receiving a configuration indicating that retransmission on a CG resource is enabled, in association with a determination that a CG retransmission timer is not configured, means for receiving a message that includes HARQ feedback for one or more CG communications, and means for transmitting a retransmission on the CG resource based at least in part on receiving the message.

In some aspects, an apparatus for wireless communication includes means for transmitting a configuration, to a UE, indicating that retransmission on a CG resource is enabled, in association with a CG retransmission timer not being configured, means for transmitting a message that includes HARQ feedback of one or more CG communications, and means for receiving a retransmission on the CG resource based at least in part on transmitting the message.

Aspects generally include a method, apparatus, system, computer program product, non-transitory computer-readable medium, user equipment, base station, wireless communication device, and/or processing system as substantially described herein with reference to and as illustrated by the drawings and specification.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

### BRIEF DESCRIPTION OF THE DRAWINGS

So that the above-recited features of the present disclosure can be understood in detail, a more particular description, briefly summarized above, may be had by reference to aspects, some of which are illustrated in the appended drawings. It is to be noted, however, that the appended drawings illustrate only certain typical aspects of this disclosure and are therefore not to be considered limiting of its scope, for the description may admit to other equally effective aspects. The same reference numbers in different drawings may identify the same or similar elements.

FIG. 1 is a diagram illustrating an example of a wireless network, in accordance with various aspects of the present disclosure.

FIG. 2 is a diagram illustrating an example of a base station in communication with a user equipment (UE) in a wireless network, in accordance with various aspects of the present disclosure.

FIG. 3 is a diagram illustrating an example of configured grant (CG) communication, in accordance with various aspects of the present disclosure.

FIG. 4 is a diagram illustrating an example of transmitting CG uplink control information if a CG retransmission timer is not configured, in accordance with various aspects of the present disclosure.

FIG. 5 is a diagram illustrating an example of indicating a buffer size, in accordance with various aspects of the present disclosure.

FIG. 6 is a diagram illustrating an example of indicating a buffer size, in accordance with various aspects of the present disclosure.

FIG. 7 is a diagram illustrating an example of transmitting retransmissions on a CG resource if a CG retransmission timer is not configured, in accordance with various aspects of the present disclosure.

FIG. 8 is a diagram illustrating examples of using a downlink feedback information for multiple hybrid automatic repeat request processes, in accordance with various aspects of the present disclosure.

FIG. 9 is a diagram illustrating an example of receiving a negative acknowledgement in downlink feedback information, in accordance with various aspects of the present disclosure.

FIG. 10 is a diagram illustrating an example process performed, for example, by a UE, in accordance with various aspects of the present disclosure.

FIG. 11 is a diagram illustrating an example process performed, for example, by a base station, in accordance with various aspects of the present disclosure.

FIG. 12 is a diagram illustrating an example process performed, for example, by a UE, in accordance with various aspects of the present disclosure.

FIG. 13 is a diagram illustrating an example process performed, for example, by a base station, in accordance with various aspects of the present disclosure.

FIGS. 14-17 are block diagrams of example apparatuses for wireless communication, in accordance with various aspects of the present disclosure.

### DETAILED DESCRIPTION

Various aspects of the disclosure are described more fully hereinafter with reference to the accompanying drawings. This disclosure may, however, be embodied in many different forms and should not be construed as limited to any specific structure or function presented throughout this disclosure. Rather, these aspects are provided so that this disclosure will be thorough and complete, and will fully convey the scope of the disclosure to those skilled in the art. Based on the teachings herein, one skilled in the art should appreciate that the scope of the disclosure is intended to cover any aspect of the disclosure disclosed herein, whether implemented independently of or combined with any other aspect of the disclosure. For example, an apparatus may be implemented or a method may be practiced using any number of the aspects set forth herein. In addition, the scope of the disclosure is intended to cover such an apparatus or method which is practiced using other structure, functionality, or structure and functionality in addition to or other than the various aspects of the disclosure set forth herein. It should be understood that any aspect of the disclosure disclosed herein may be embodied by one or more elements of a claim.

Several aspects of telecommunication systems will now be presented with reference to various apparatuses and techniques. These apparatuses and techniques will be described in the following detailed description and illustrated in the accompanying drawings by various blocks, modules, components, circuits, steps, processes, algorithms, and/or the like (collectively referred to as “elements”). These elements may be implemented using hardware, software, or combinations thereof. Whether such elements are implemented as hardware or software depends upon the particular application and design constraints imposed on the overall system.

It should be noted that while aspects may be described herein using terminology commonly associated with a 5G or NR radio access technology (RAT), aspects of the present disclosure can be applied to other RATs, such as a 3G RAT, a 4G RAT, and/or a RAT subsequent to 5G (e.g., 6G).

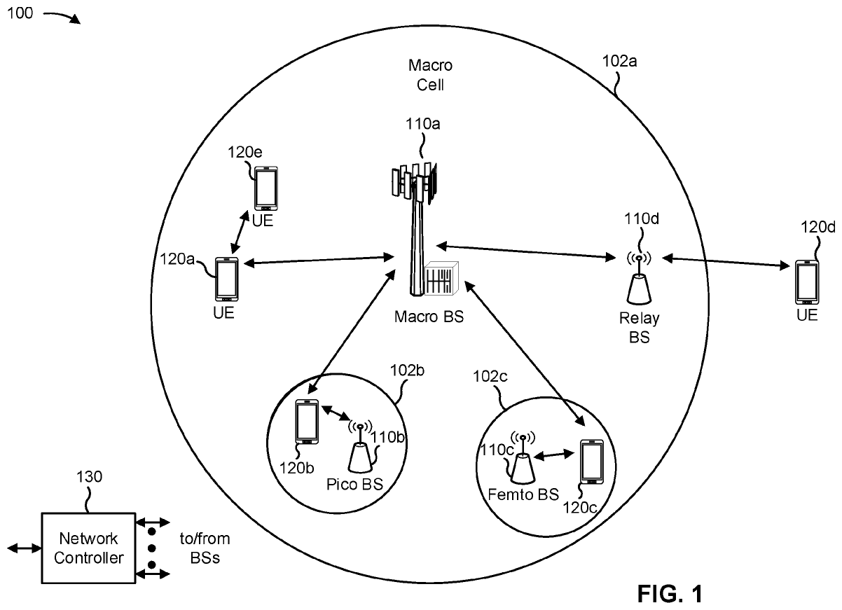

FIG. 1 is a diagram illustrating an example of a wireless network 100, in accordance with various aspects of the present disclosure. The wireless network 100 may be or may include elements of a 5G (NR) network, an LTE network, and/or the like. The wireless network 100 may include a number of base stations 110 (shown as BS 110a, BS 110b, BS 110c, and BS 110d) and other network entities. A base station (BS) is an entity that communicates with user equipment (UEs) and may also be referred to as an NR BS, a Node B, a gNB, a 5G node B (NB), an access point, a transmit receive point (TRP), and/or the like. Each BS may provide communication coverage for a particular geographic area. In 3GPP, the term “cell” can refer to a coverage area of a BS and/or a BS subsystem serving this coverage area, depending on the context in which the term is used.

A BS may provide communication coverage for a macro cell, a pico cell, a femto cell, and/or another type of cell. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having association with the femto cell (e.g., UEs in a closed subscriber group (CSG)). ABS for a macro cell may be referred to as a macro BS. A BS for a pico cell may be referred to as a pico BS. ABS for a femto cell may be referred to as a femto BS or a home BS. In the example shown in FIG. 1, a BS 110a may be a macro BS for a macro cell 102a, a BS 110b may be a pico BS for a pico cell 102b, and a BS 110c may be a femto BS for a femto cell 102c. ABS may support one or multiple (e.g., three) cells. The terms “eNB”, “base station”, “NR BS”, “gNB”, “TRP”, “AP”, “node B”, “5G NB”, and “cell” may be used interchangeably herein.

In some aspects, a cell may not necessarily be stationary, and the geographic area of the cell may move according to the location of a mobile BS. In some aspects, the BSs may be interconnected to one another and/or to one or more other BSs or network nodes (not shown) in the wireless network 100 through various types of backhaul interfaces such as a direct physical connection, a virtual network, and/or the like using any suitable transport network.

Wireless network 100 may also include relay stations. A relay station is an entity that can receive a transmission of data from an upstream station (e.g., a BS or a UE) and send a transmission of the data to a downstream station (e.g., a UE or a BS). A relay station may also be a UE that can relay transmissions for other UEs. In the example shown in FIG. 1, a relay BS 110d may communicate with macro BS 110a and a UE 120d in order to facilitate communication between BS 110a and UE 120d. A relay BS may also be referred to as a relay station, a relay base station, a relay, and/or the like.

Wireless network 100 may be a heterogeneous network that includes BSs of different types, e.g., macro BSs, pico BSs, femto BSs, relay BSs, and/or the like. These different types of BSs may have different transmit power levels, different coverage areas, and different impacts on interference in wireless network 100. For example, macro BSs may have a high transmit power level (e.g., 5 to 40 watts) whereas pico BSs, femto BSs, and relay BSs may have lower transmit power levels (e.g., 0.1 to 2 watts).

A network controller 130 may couple to a set of BSs and may provide coordination and control for these BSs. Network controller 130 may communicate with the BSs via a backhaul. The BSs may also communicate with one another, e.g., directly or indirectly via a wireless or wireline backhaul.

UEs 120 (e.g., 120a, 120b, 120c) may be dispersed throughout wireless network 100, and each UE may be stationary or mobile. A UE may also be referred to as an access terminal, a terminal, a mobile station, a subscriber unit, a station, and/or the like. A UE may be a cellular phone (e.g., a smart phone), a personal digital assistant (PDA), a wireless modem, a wireless communication device, a handheld device, a laptop computer, a cordless phone, a wireless local loop (WLL) station, a tablet, a camera, a gaming device, a netbook, a smartbook, an ultrabook, a medical device or equipment, biometric sensors/devices, wearable devices (smart watches, smart clothing, smart glasses, smart wrist bands, smart jewelry (e.g., smart ring, smart bracelet)), an entertainment device (e.g., a music or video device, or a satellite radio), a vehicular component or sensor, smart meters/sensors, industrial manufacturing equipment, a global positioning system device, or any other suitable device that is configured to communicate via a wireless or wired medium.

Some UEs may be considered machine-type communication (MTC) or evolved or enhanced machine-type communication (eMTC) UEs. MTC and eMTC UEs include, for example, robots, drones, remote devices, sensors, meters, monitors, location tags, and/or the like, that may communicate with a base station, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, and/or may be implemented as NB-IoT (narrowband internet of things) devices. Some UEs may be considered a Customer Premises Equipment (CPE). UE 120 may be included inside a housing that houses components of UE 120, such as processor components, memory components, and/or the like. In some aspects, the processor components and the memory components may be coupled together. For example, the processor components (e.g., one or more processors) and the memory components (e.g., a memory) may be operatively coupled, communicatively coupled, electronically coupled, electrically coupled, and/or the like.

In general, any number of wireless networks may be deployed in a given geographic area. Each wireless network may support a particular RAT and may operate on one or more frequencies. A RAT may also be referred to as a radio technology, an air interface, and/or the like. A frequency may also be referred to as a carrier, a frequency channel, and/or the like. Each frequency may support a single RAT in a given geographic area in order to avoid interference between wireless networks of different RATs. In some cases, NR or 5G RAT networks may be deployed.

In some aspects, two or more UEs 120 (e.g., shown as UE 120a and UE 120e) may communicate directly using one or more sidelink channels (e.g., without using a base station 110 as an intermediary to communicate with one another). For example, the UEs 120 may communicate using peer-to-peer (P2P) communications, device-to-device (D2D) communications, a vehicle-to-everything (V2X) protocol (e.g., which may include a vehicle-to-vehicle (V2V) protocol, a vehicle-to-infrastructure (V2I) protocol, and/or the like), a mesh network, and/or the like. In this case, the UE 120 may perform scheduling operations, resource selection operations, and/or other operations described elsewhere herein as being performed by the base station 110.

Devices of wireless network 100 may communicate using the electromagnetic spectrum, which may be subdivided based on frequency or wavelength into various classes, bands, channels, and/or the like. For example, devices of wireless network 100 may communicate using an operating band having a first frequency range (FR1), which may span from 410 MHz to 7.125 GHz, and/or may communicate using an operating band having a second frequency range (FR2), which may span from 24.25 GHz to 52.6 GHz. The frequencies between FR1 and FR2 are sometimes referred to as mid-band frequencies. Although a portion of FR1 is greater than 6 GHz, FR1 is often referred to as a “sub-6 GHz” band. Similarly, FR2 is often referred to as a “millimeter wave” band despite being different from the extremely high frequency (EHF) band (30 GHz-300 GHz) which is identified by the International Telecommunications Union (ITU) as a “millimeter wave” band. Thus, unless specifically stated otherwise, it should be understood that the term “sub-6 GHz” or the like, if used herein, may broadly represent frequencies less than 6 GHz, frequencies within FR1, and/or mid-band frequencies (e.g., greater than 7.125 GHz). Similarly, unless specifically stated otherwise, it should be understood that the term “millimeter wave” or the like, if used herein, may broadly represent frequencies within the EHF band, frequencies within FR2, and/or mid-band frequencies (e.g., less than 24.25 GHz). It is contemplated that the frequencies included in FR1 and FR2 may be modified, and techniques described herein are applicable to those modified frequency ranges.

As indicated above, FIG. 1 is provided as an example. Other examples may differ from what is described with regard to FIG. 1.

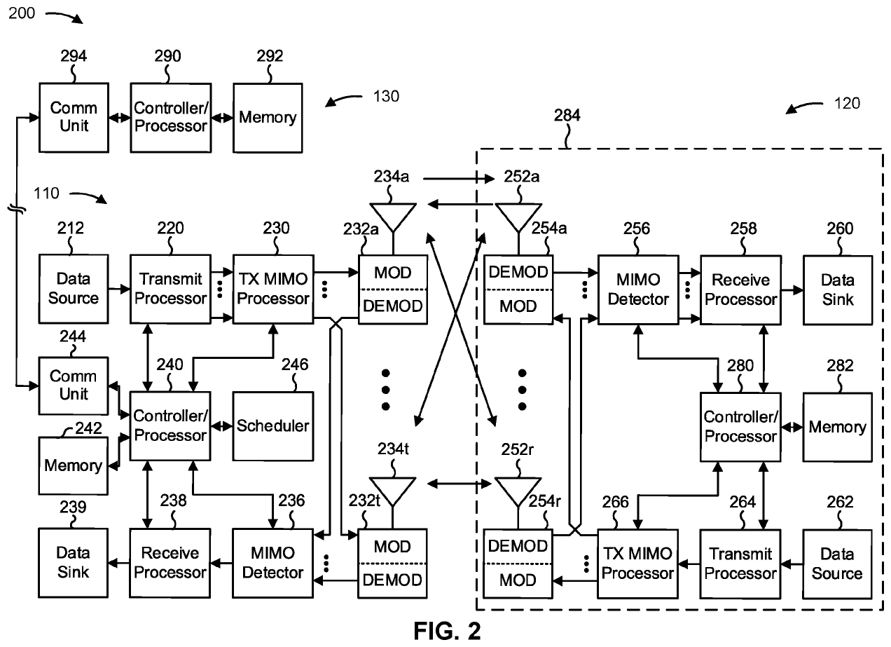

FIG. 2 is a diagram illustrating an example 200 of a base station 110 in communication with a UE 120 in a wireless network 100, in accordance with various aspects of the present disclosure. Base station 110 may be equipped with T antennas 234a through 234t, and UE 120 may be equipped with R antennas 252a through 252r, where in general T≥1 and R≥1.

At base station 110, a transmit processor 220 may receive data from a data source 212 for one or more UEs, select one or more modulation and coding schemes (MCS) for each UE based at least in part on channel quality indicators (CQIs) received from the UE, process (e.g., encode and modulate) the data for each UE based at least in part on the MCS(s) selected for the UE, and provide data symbols for all UEs. Transmit processor 220 may also process system information (e.g., for semi-static resource partitioning information (SRPI) and/or the like) and control information (e.g., CQI requests, grants, upper layer signaling, and/or the like) and provide overhead symbols and control symbols. Transmit processor 220 may also generate reference symbols for reference signals (e.g., a cell-specific reference signal (CRS), a demodulation reference signal (DMRS), and/or the like) and synchronization signals (e.g., the primary synchronization signal (PSS) and secondary synchronization signal (SSS)). A transmit (TX) multiple-input multiple-output (MIMO) processor 230 may perform spatial processing (e.g., precoding) on the data symbols, the control symbols, the overhead symbols, and/or the reference symbols, if applicable, and may provide T output symbol streams to T modulators (MODs) 232a through 232t. Each modulator 232 may process a respective output symbol stream (e.g., for OFDM and/or the like) to obtain an output sample stream. Each modulator 232 may further process (e.g., convert to analog, amplify, filter, and upconvert) the output sample stream to obtain a downlink signal. T downlink signals from modulators 232a through 232t may be transmitted via T antennas 234a through 234t, respectively.

At UE 120, antennas 252a through 252r may receive the downlink signals from base station 110 and/or other base stations and may provide received signals to demodulators (DEMODs) 254a through 254r, respectively. Each demodulator 254 may condition (e.g., filter, amplify, downconvert, and digitize) a received signal to obtain input samples. Each demodulator 254 may further process the input samples (e.g., for OFDM and/or the like) to obtain received symbols. A MIMO detector 256 may obtain received symbols from all R demodulators 254a through 254r, perform MIMO detection on the received symbols if applicable, and provide detected symbols. A receive processor 258 may process (e.g., demodulate and decode) the detected symbols, provide decoded data for UE 120 to a data sink 260, and provide decoded control information and system information to a controller/processor 280. The term “controller/processor” may refer to one or more controllers, one or more processors, or a combination thereof. A channel processor may determine reference signal received power (RSRP), received signal strength indicator (RSSI), reference signal received quality (RSRQ), channel quality indicator (CQI), and/or the like. In some aspects, one or more components of UE 120 may be included in a housing 284.

Network controller 130 may include communication unit 294, controller/processor 290, and memory 292. Network controller 130 may include, for example, one or more devices in a core network. Network controller 130 may communicate with base station 110 via communication unit 294.

On the uplink, at UE 120, a transmit processor 264 may receive and process data from a data source 262 and control information (e.g., for reports that include RSRP, RSSI, RSRQ, CQI, and/or the like) from controller/processor 280. Transmit processor 264 may also generate reference symbols for one or more reference signals. The symbols from transmit processor 264 may be precoded by a TX MIMO processor 266 if applicable, further processed by modulators 254a through 254r (e.g., for DFT-s-OFDM, CP-OFDM, and/or the like), and transmitted to base station 110. In some aspects, the UE 120 includes a transceiver. The transceiver may include any combination of antenna(s) 252, modulators and/or demodulators 254, MIMO detector 256, receive processor 258, transmit processor 264, and/or TX MIMO processor 266. The transceiver may be used by a processor (e.g., controller/processor 280) and memory 282 to perform aspects of any of the methods described herein, for example, as described with reference to FIGS. 1-17.

At base station 110, the uplink signals from UE 120 and other UEs may be received by antennas 234, processed by demodulators 232, detected by a MIMO detector 236 if applicable, and further processed by a receive processor 238 to obtain decoded data and control information sent by UE 120. Receive processor 238 may provide the decoded data to a data sink 239 and the decoded control information to controller/processor 240. Base station 110 may include communication unit 244 and communicate to network controller 130 via communication unit 244. Base station 110 may include a scheduler 246 to schedule UEs 120 for downlink and/or uplink communications. In some aspects, the base station 110 includes a transceiver. The transceiver may include any combination of antenna(s) 234, modulators and/or demodulators 232, MIMO detector 236, receive processor 238, transmit processor 220, and/or TX MIMO processor 230. The transceiver may be used by a processor (e.g., controller/processor 240) and memory 242 to perform aspects of any of the methods described herein, for example, as described with reference to FIGS. 1-17.

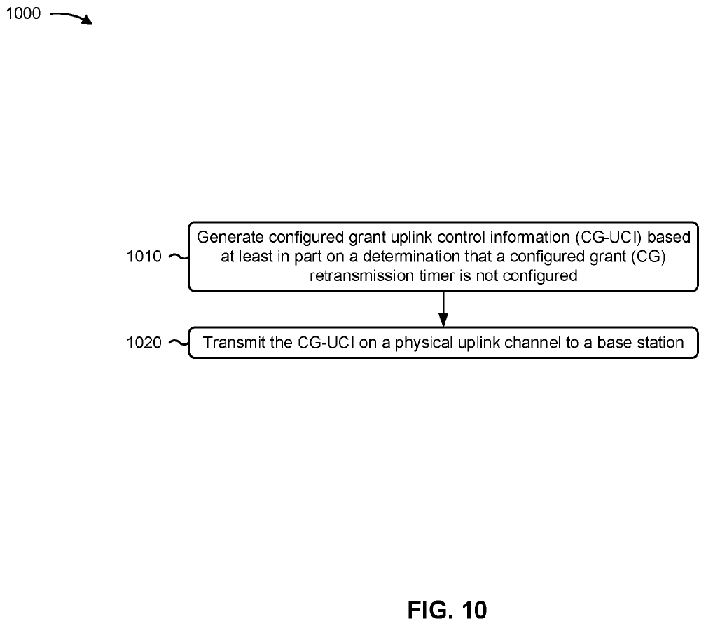

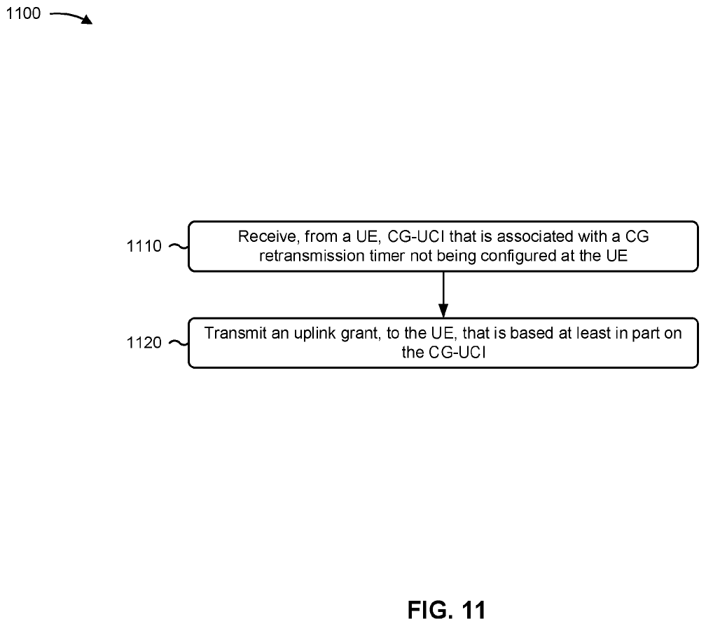

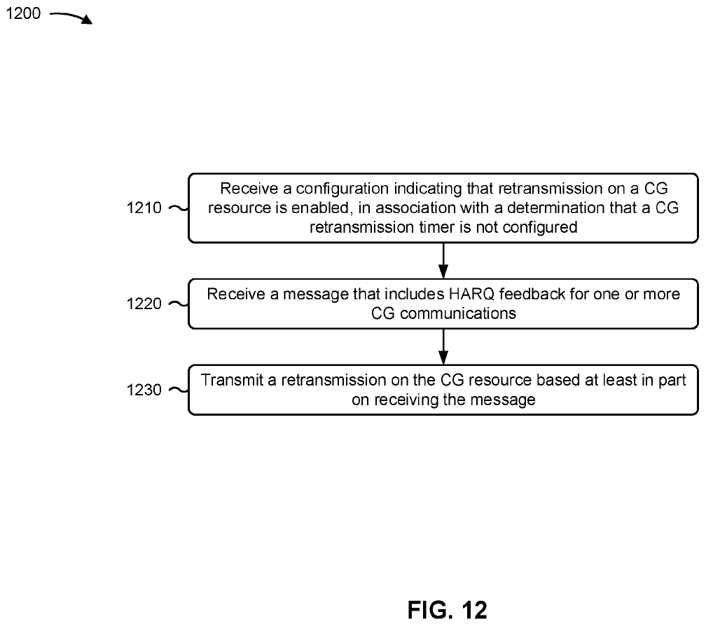

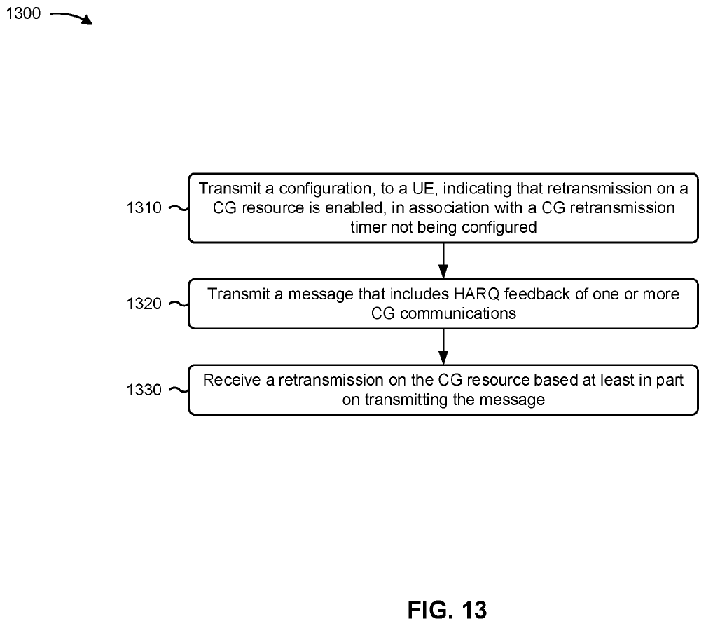

Controller/processor 240 of base station 110, controller/processor 280 of UE 120, and/or any other component(s) of FIG. 2 may perform one or more techniques associated with transmitting configured grant (CG) uplink control information or retransmissions if a CG retransmission timer is not configured, as described in more detail elsewhere herein. For example, controller/processor 240 of base station 110, controller/processor 280 of UE 120, and/or any other component(s) of FIG. 2 may perform or direct operations of, for example, process 1000 of FIG. 10, process 1100 of FIG. 11, process 1200 of FIG. 12, process 1300 of FIG. 13, and/or other processes as described herein. Memories 242 and 282 may store data and program codes for base station 110 and UE 120, respectively. In some aspects, memory 242 and/or memory 282 may include a non-transitory computer-readable medium storing one or more instructions (e.g., code, program code, and/or the like) for wireless communication. For example, the one or more instructions, when executed (e.g., directly, or after compiling, converting, interpreting, and/or the like) by one or more processors of the base station 110 and/or the UE 120, may cause the one or more processors, the UE 120, and/or the base station 110 to perform or direct operations of, for example, process 1000 of FIG. 10, process 1100 of FIG. 11, process 1200 of FIG. 12, process 1300 of FIG. 13, and/or other processes as described herein. In some aspects, executing instructions may include running the instructions, converting the instructions, compiling the instructions, interpreting the instructions, and/or the like.

In some aspects, UE 120 includes means for generating CG-UCI based at least in part on a determination that a CG retransmission timer is not configured, and/or means for transmitting the CG-UCI on a physical uplink channel to a base station. The means for UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, UE 120 includes means for receiving an uplink grant for a retransmission based at least in part on transmitting the CG-UCI, and/or means for transmitting the retransmission after receiving the uplink grant for the retransmission.

In some aspects, UE 120 includes means for determining one or more of the HARQ process identifier or the RV identifier.

In some aspects, UE 120 includes means for determining that the COT sharing information indicates that the base station is able to share the COT based at least in part on a determination that energy detected in a channel satisfies one or more energy detection thresholds.

In some aspects, UE 120 includes means for sharing the COT to the base station.

In some aspects, base station 110 includes means for receiving, from a UE, CG-UCI that is associated with a CG retransmission timer not being configured at the UE, and/or means for transmitting an uplink grant, to the UE, that is based at least in part on the CG-UCI. The means for base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, base station 110 includes means for sharing the COT based at least in part on the COT sharing information.

In some aspects, base station 110 includes means for restricting downlink transmission power in the COT based at least in part on the CG-UCI.

In some aspects, base station 110 includes means for transmitting configuration information for the CG-UCI in a radio resource control message.

In some aspects, base station 110 includes means for receiving a retransmission after receiving the CG-UCI.

In some aspects, UE 120 includes means for receiving a configuration indicating that retransmission on a CG resource is enabled, in association with a determination that a CG retransmission timer is not configured, means for receiving a message that includes HARQ feedback for one or more CG communications, and/or means for transmitting a retransmission on the CG resource based at least in part on receiving the message. The means for UE 120 to perform operations described herein may include, for example, antenna 252, demodulator 254, MIMO detector 256, receive processor 258, transmit processor 264, TX MIMO processor 266, modulator 254, controller/processor 280, and/or memory 282.

In some aspects, UE 120 includes means for transmitting one or more of a HARQ process identifier or a redundancy version (RV) identifier in CG-UCI based at least in part on a determination that a HARQ process identifier or an RV identifier is to be included in the CG-UCI.

In some aspects, UE 120 includes means for refraining from transmitting one or more of a HARQ process identifier or a redundancy version (RV) identifier in CG-UCI based at least in part on a determination that a HARQ process identifier or an RV identifier is not to be included in the CG-UCI.

In some aspects, UE 120 includes means for transmitting CG-UCI with a new data indicator based at least in part on whether the CG-UCI is for a retransmission or a new uplink communication.

In some aspects, base station 110 includes means for transmitting a configuration, to a UE, indicating that retransmission on a CG resource is enabled, in association with a CG retransmission timer not being configured, means for transmitting a message that includes HARQ feedback of one or more CG communications, and/or means for receiving a retransmission on the CG resource based at least in part on transmitting the message. The means for base station 110 to perform operations described herein may include, for example, transmit processor 220, TX MIMO processor 230, modulator 232, antenna 234, demodulator 232, MIMO detector 236, receive processor 238, controller/processor 240, memory 242, and/or scheduler 246.

In some aspects, base station 110 includes means for receiving CG-UCI with a new data indicator indicating whether the CG-UCI is for a retransmission or a new uplink communication.

While blocks in FIG. 2 are illustrated as distinct components, the functions described above with respect to the blocks may be implemented in a single hardware, software, or combination component or in various combinations of components. For example, the functions described with respect to the transmit processor 264, the receive processor 258, and/or the TX MIMO processor 266 may be performed by or under the control of controller/processor 280.

As indicated above, FIG. 2 is provided as an example. Other examples may differ from what is described with regard to FIG. 2.

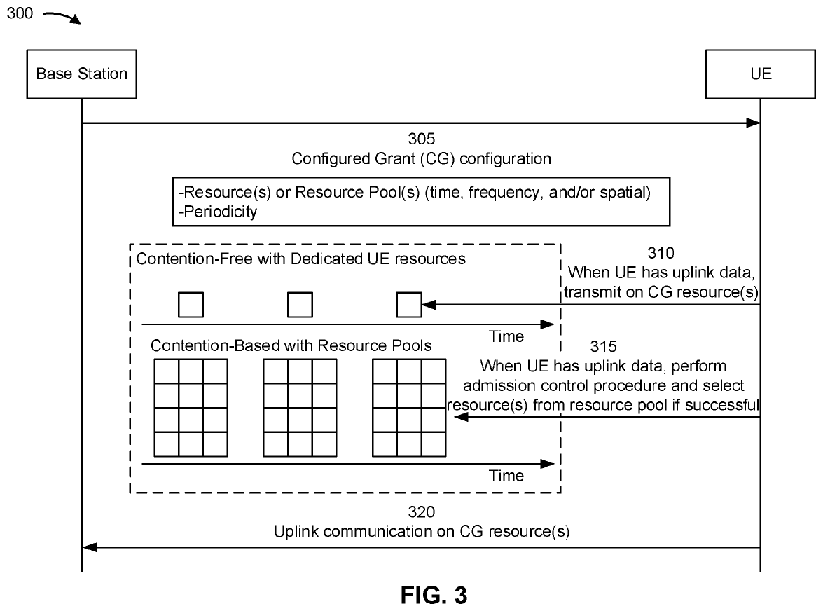

FIG. 3 is a diagram illustrating an example 300 of CG communication, in accordance with various aspects of the present disclosure. As shown, example 300 includes a base station and a UE.

As shown in FIG. 3, and by reference number 305, the base station may transmit a CG configuration to the UE. For example, the base station may transmit configuration information (e.g., in a radio resource configuration (RRC) message, in a downlink control information (DCI) message) that identifies the CG. In some aspects, the configuration information identifying the CG may indicate a resource allocation (e.g., in a time domain, frequency domain, spatial domain, code domain) or a periodicity associated with the resource allocation. The CG may identify a resource or set of resources available to the UE for transmission of an uplink communication (e.g., data, control information). For example, the CG configuration may identify a resource allocation for a physical uplink shared channel (PUSCH). In some aspects, the CG configuration may identify a resource pool or multiple resource pools that may be available to the UE for an uplink transmission.

In some aspects, the CG configuration may configure contention-free CG communication with resources dedicated for the UE to transmit uplink communications. In this case, the CG configuration may indicate a resource allocation dedicated for the UE to use to transmit uplink communications. In some aspects, the CG configuration may configure the resource allocation for the UE to occur periodically, such that the resource allocation corresponds to periodically occurring transmission time occasions. As shown in FIG. 3, and by reference number 310, when the UE has uplink data to transmit, the UE transmits the uplink data in the CG resources identified by the CG configuration. For example, the UE transmits the uplink data in one of the CG uplink occasions identified in the CG configuration using the configured resource allocation.

A CG configuration with regular periodic CG uplink occasions with a dedicated resource allocation for the UE may be convenient for a UE with periodic uplink traffic (e.g., with trivial jitter). The CG configuration may configure the periodicity associated with the resource allocation to associate CG uplink occasions with periodic nominal arrival times at which traffic to be transmitted to the base station is expected to arrive at (or be ready to be transmitted by) the UE. However, the actual arrival times at which the traffic arrives (or is ready to be transmitted) by the UE may be different than the nominal arrival times, and this difference in times is known as jitter. In some aspects, traffic uttering may be handled by configuring multiple CGs around the nominal arrival times. In some aspects, multiple opportunities for the UE to transmit the uplink communication may be defined within a CG uplink occasion. The UE may be configured with multiple CG uplinks to allow the UE to repeatedly transmit the CG uplink communications and increase the likelihood that the base station receives the communications. NR CG uplink may depend on dynamic grant re-transmission. In some aspects, to suppress a quantity of dynamic grants, the CG can be configured with blind re-transmissions via multiple repetitions per occasion.

In some cases, CG configurations with dedicated resources allocated per UE may be inefficient. For example, CG configurations with dedicated UE resources for a large number of UEs may result in consumption of an excessive amount of PUSCH resources. In this case, a considerable portion of the PUSCH resources may be inefficiently utilized, which reduces system capacity. For example, when multiple CG configurations for a UE are used for de-jittering, only a subset of CG resources may be effectively utilized. In another example, when multiple transmission opportunities are defined per CG uplink occasion, only one opportunity may be effectively utilized. In yet another example, when a blind repetition scheme is used for re-transmissions, a packet may have been already decoded after the first one or more repetitions (early decoding) such that a remainder of the repetitions are unnecessary. Unlike a downlink case, this type of inefficient consumption of system resources cannot be addressed by scheduling, as the base station does not know exactly when traffic will arrive at the UEs.

As shown in FIG. 3, the CG configuration may configure contention-based CG communication with resource pools that are available for multiple UEs to use to transmit uplink communications. The contention-based CG configuration uses statistical multiplexing to share the resource pools among multiple UEs. A resource pool includes multiple resources (e.g., in a time domain, frequency domain, spatial domain, code domain, and/or the like) that can be allocated for uplink transmission for one or more UEs. For example, an x-axis of an illustrated resource pool may indicate transmission times and a y-axis of the illustrated resource pool may indicate resources (e.g., frequency domain, spatial domain, code domain, and/or the like) that can be allocated at each transmission time. In some aspects, the same resource pools may be configured for multiple UEs.

As further shown in FIG. 3, and by reference number 315, for the contention-based CG configuration, when the UE has uplink data to be transmitted, the UE performs an admission control procedure and selects one or more resources from the resource pool if the admission control procedure is successful. In some aspects, the admission control procedure may include the UE selecting a random number (e.g., between 0 and 1 or some other range), comparing the random number and a threshold, and determining whether the random number satisfies the threshold. If the random number satisfies the threshold, then the admission is successful, and the UE selects a resource from the resource pool to transmit the uplink communication.

In some aspects, the base station may control the probability of the UE accessing the resource pool by setting and/or adjusting the threshold. For example, the base station may dynamically adjust the threshold to permit more or fewer UEs to access the resource pool in order to prevent resource collisions. Additionally, or alternatively, the base station may assign different thresholds to be used by different UEs.

Based at least in part on the UE determining that the random number satisfies the threshold, the UE may select a resource from the resource pool to transmit the uplink communication. The UE may select the resource from the resource pool using randomized and/or pseudo-randomized resource selection. For example, the UE may use a hashing function based at least in part on a UE identifier, time, and/or resource pool index to select the resource from the resource pool.

As further shown in FIG. 3, and by reference number 320, the UE transmits the uplink communication to the base station on the CG resource. For example, the UE may transmit the uplink communication as a PUSCH communication using a resource allocation identified by the CG.

In some aspects, the UE may be configured to start a CG retransmission timer when the UE transmits, to a base station, an uplink communication scheduled by an uplink grant associated with a HARQ process. CG retransmission (or CG transmission) may be prohibited during the CG retransmission timer. The CG retransmission timer will stop when downlink feedback information (DFI), such as HARQ feedback, is received. If the UE does not receive DFI by expiration of the CG retransmission timer, the UE may interpret the expiration of the CG retransmission timer as a negative acknowledgement (NACK) for the HARQ process. If the UE determines there is a NACK for the HARQ process, the UE may transmit a retransmission on a CG resource. The CG retransmission timer may be configured per CG or per HARQ process.

As indicated above, FIG. 3 is provided as an example. Other examples may differ from what is described with respect to FIG. 3.

A UE using an unlicensed frequency band may perform a Listen-Before-Talk (LBT) procedure to determine if a channel is clear. If the UE does not detect enough energy on the channel, the UE may determine that the UE can use the channel for a period of time. The period of time may be considered a channel occupancy time (COT) for the UE, and a length of the COT may be subject to a maximum COT. In some aspects, the UE may indicate to a base station that the base station may share the UE COT. This sharing may be referred to as “UE to gNB COT sharing.”

UE to gNB COT sharing may be supported for a semi-static channel access mode. A gNB may determine that a COT in a fixed frame period (FFP) is associated with, or initiated by, a UE if the gNB detects an uplink transmission from the UE starting from a beginning of the FFP and ending before an idle period of the FFP. If the gNB determines that the UE has initiated a COT in an FFP, the gNB may transmit within the FFP and before the idle period of the FFP. For frame-based equipment (FBE) mode, configuration of a CG retransmission timer (e.g., cg-RetransmissionTimer) may not be mandated when CG Type 1 or CG Type 2 is configured on unlicensed spectrum. However, if CG retransmission is not configured, the UE may not transmit CG-UCI, which may include information such as COT sharing information. A UE may use a configured energy detection threshold for LBT for COT sharing, but the UE may use a less-sensitive threshold for non-COT sharing. If the gNB has no downlink data to transmit after an uplink communication, the UE may not need to share a COT to the gNB. If the energy detection threshold is more sensitive than necessary, the UE may not use a sensed channel and may waste time, power, processing resources, and signaling resources preparing to use another channel or waiting to transmit on the channel later.

According to various aspects described herein, a UE may transmit CG-UCI, even if a CG retransmission timer is not configured. In this way, the UE may transmit information such as COT sharing information, HARQ information, a buffer status report (BSR), or a combination thereof to a base station. For example, if the UE is able to transmit COT sharing information to the base station, the UE may be configured to use a more appropriate energy detection threshold such that the UE may use a channel that is available. As a result, the UE conserves time, power, processing resources, and signaling resources.

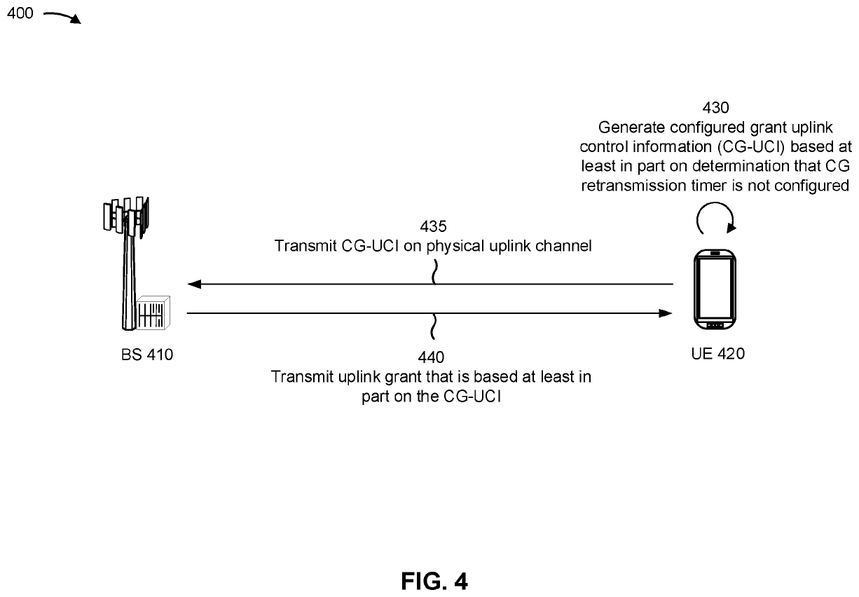

FIG. 4 is a diagram illustrating an example 400 of transmitting CG-UCI if a CG retransmission timer is not configured, in accordance with various aspects of the present disclosure. As shown in FIG. 4, example 400 includes communication between a BS 410 and a UE 420. In some aspects, BS 410 and UE 420 may be included in a wireless network, such as wireless network 100. BS 410 and UE 420 may communicate on a wireless access link, which may include an uplink and a downlink. BS 410 may have configured UE 420 for CG.

As shown by reference number 430, UE 420 may generate CG-UCI based at least in part on a determination that a CG retransmission timer is not configured. BS 410 may configure UE 420, via RRC, to transmit the CG-UCI in a configuration that is separate from a configuration for the CG retransmission timer. BS 410 may configure the fields in the CG-UCI and whether the CG-UCI is included on a CG-PUSCH. The configuration may be explicit or implicit. An implicit example may include UE 420 transmitting CG-UCI if configuration information for COT sharing is included in a configuration from BS 410. In some aspects, the CG-UCI may include HARQ information such as a HARQ process identifier, an RV identifier, and/or a new data indicator (NDI) depending on whether retransmission on a CG resource is configured. The CG-UCI may also include COT sharing information and/or a BSR.

As for including COT sharing information in the CG-UCI, UE 420 may include a bit to indicate COT sharing information or energy detection threshold information. For example, UE 420 may select a configured energy detection threshold for LBT at a time instance and set a value of the bit to “1,” and BS 410 may share a COT of the UE. If UE 420 selects an energy detection threshold that is calculated based at least in part on a UE transmit power, UE 420 may set the value of the bit to “0,” and BS 410 may not share the UE COT. In some aspects, BS 410 may share the UE COT, but with a restriction on a downlink transmit power. The downlink transmit power may not be larger than a maximum UE transmit power. In this way, compared to a hardcoded energy detection threshold, a probability of channel access is increased.

In some aspects, UE 420 may use multiple energy detection thresholds for LBT at one time instance. UE 420 may use a bit to indicate COT sharing information. For example, if an energy detection satisfies both a first energy detection threshold (e.g., configured energy detection threshold) and a second energy detection threshold (e.g., energy detection threshold calculated based at least in part on the UE transmit power), UE 420 may set a value of the bit to “1,” and BS 410 may share the UE COT. If the energy detection satisfies the second energy detection threshold but not the first energy detection threshold, UE 420 may set the value of the bit to “0,” and the BS 410 may not share the UE COT or shares the UE COT with a restriction on downlink transmit power. In this way, the probability of channel access is increased, because UE 420 may be able to use the calculated energy detection threshold.

In some aspects, BS 410 may configure UE 420 with multiple energy detection thresholds, and UE 420 may use multiple energy detection thresholds for LBT at one time instance. A minimum energy detection threshold may correspond to a transmit power of BS 410, and a maximum energy detection threshold may correspond to a transmit power of UE 420. In some aspects, multiple bits (e.g., log₂(N)) bits in the CG-UCI may be used to indicate a minimum energy detection threshold that is larger than a detected energy.

For example, a bit field of “00” may indicate a first threshold where BS 410 may share the UE COT, and a maximum downlink transmit power may be a first power value that corresponds to a maximum transmit power of BS 410. A bit field of “01” may indicate a second threshold where BS 410 may share the UE COT with a restriction on downlink transmit power, and a maximum downlink transmit power may be a second power value that is less than the first power value. A bit field of “10” may indicate a third threshold where BS 410 may share the UE COT with a restriction on downlink transmit power, and a maximum downlink transmit power may be a third power value that is less than the second power value. A bit field of “11” may indicate a fourth threshold where BS 410 may share the UE COT with a restriction on downlink transmit power, and a maximum downlink transmit power may be a fourth power value that corresponds to a maximum UE transmit power and is less than the third power value. By providing different options for an energy detection threshold, the downlink transmit power may be further relaxed.

In some aspects, the CG-UCI may include HARQ information. For ultra-reliable low-latency communication (URLLC) in licensed spectrum, a HARQ process identifier may be determined based at least in part on an equation that is related to transmission occasions, and an initial transmission can only start at fixed transmission occasions based on a configured RV sequence. This may restrict CG resource utilization. With the introduction of CG-UCI for unlicensed spectrum, more flexibility on CG resource utilization may be achieved for URLLC in unlicensed spectrum. In some aspects, when a CG retransmission timer is not configured, if HARQ information is configured to be included in the CG-UCI, and the CG-UCI is configured to be included on a CG-PUSCH, UE 420 may select a HARQ process identifier from among multiple HARQ process identifiers that are available for CG configuration. UE 420 may also determine an RV for an uplink communication with a CG. The CG-UCI may include a HARQ process identifier, an RV identifier, and/or an NDI if retransmission on a CG resource is enabled.

In some aspects, the CG-UCI may include a BSR. A BSR procedure may be used to provide a serving base station with information about uplink data volume in a medium access control (MAC) entity. UE 420 may transmit a BSR in a MAC control element (MAC CE) on a PUSCH. Because PUSCH decoding performance may be worse than CG-UCI decoding performance, UE 420 may transmit the BSR in the CG-UCI, which may increase a reliability of the BSR. After receiving the BSR in the CG-UCI, BS 410 may perform appropriate scheduling based at least in part on the BSR. A BSR MAC CE may include a short BSR format (fixed size), a long BSR format (variable size), a short truncated BSR format (fixed size), or a long truncated BSR format (variable size). A truncated BSR format may be related to padding a BSR, which is transmitted in padding bits of an uplink resource. When the BSR is transmitted in the CG-UCI, a truncated BSR format may not be needed.

As shown by reference number 435, UE 420 may transmit the CG-UCI on a physical uplink channel. The physical uplink channel may be a PUSCH or a physical uplink control channel. As shown by reference number 440, BS 410 may transmit an uplink grant for a retransmission or a new uplink transmission, based at least in part on the CG-UCI.

As indicated above, FIG. 4 is provided as an example. Other examples may differ from what is described with regard to FIG. 4.

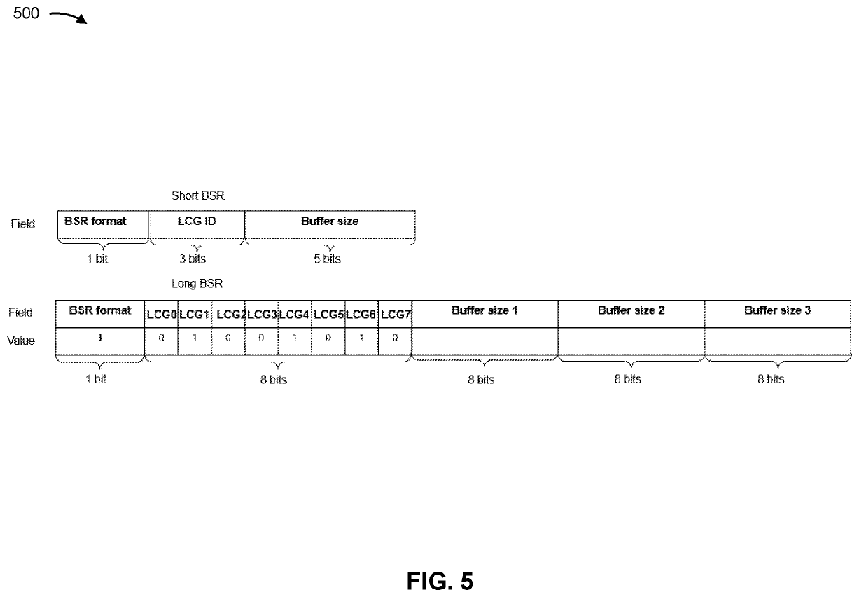

FIG. 5 is a diagram illustrating an example 500 of indicating a buffer size, in accordance with various aspects of the present disclosure.

If the BSR is configured to be included in the CG-UCI, UE 420 may use a bit to indicate a BSR format. For example, if a bit value is “0,” a short BSR is transmitted. If the bit value is “1,” a long BSR is transmitted. A UE may indicate a buffer size by reusing an existing specified table for mapping between a buffer size level and a buffer size field index.

Example 500 shows fields of tables for indicating a buffer size. For a short BSR, 3 bits may be used to indicate a logical channel group (LCG) identifier, and 5 bits may be used to indicate a buffer size of the LCG identifier. For a long BSR, 8 bits may be used to indicate whether the buffer size field of a specific LCG identifier is present. If the buffer field is present, buffer size fields may be included in ascending order based at least in part on the LCG identifier. For each buffer size field, 8 bits may be used to indicate the buffer size.

As indicated above, FIG. 5 is provided as an example. Other examples may differ from what is described with regard to FIG. 5.

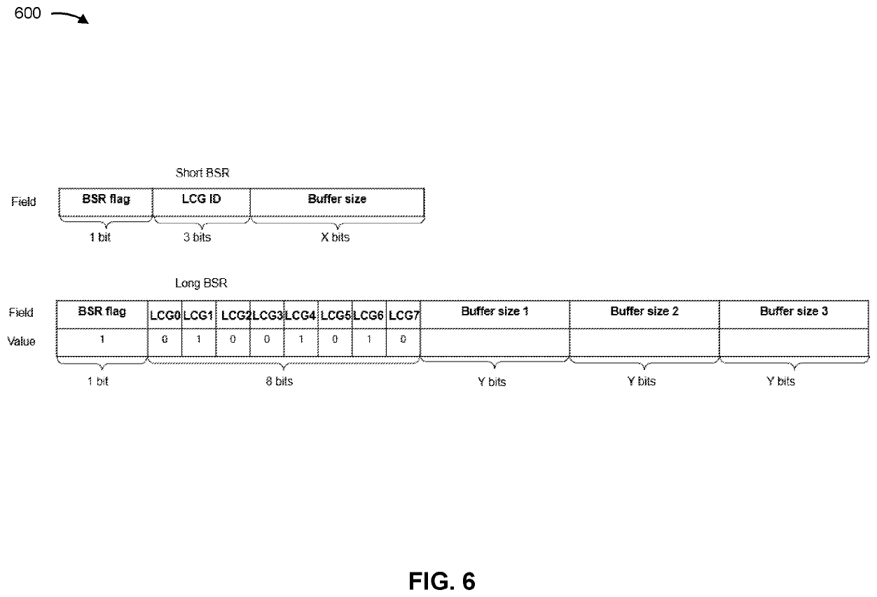

FIG. 6 is a diagram illustrating an example 600 of indicating a buffer size, in accordance with various aspects of the present disclosure.

A UE may indicate a buffer size by using a new table for mapping between a buffer size level and a buffer size field index. This may reduce overhead for a CG-UCI.

Example 600 shows fields of tables for indicating a buffer size. For a short BSR, 3 bits may be used to indicate a logical channel group (LCG) identifier, and Xbits may be used to indicate a buffer size of the LCG identifier. The UE may determine X based at least in part on a quantity of entries in the table. For a long BSR, 8 bits may be used to indicate whether the buffer size field of a specific LCG identifier is present. If the buffer field is present, buffer size fields may be included in ascending order based at least in part on the LCG identifier. For each buffer size field, Y bits may be used to indicate the buffer size, where the UE determines Y based at least in part on a quantity of entries in the table. A table for a short BSR may be different than a table for a long BSR.

As indicated above, FIG. 6 is provided as an example. Other examples may differ from what is described with regard to FIG. 6.

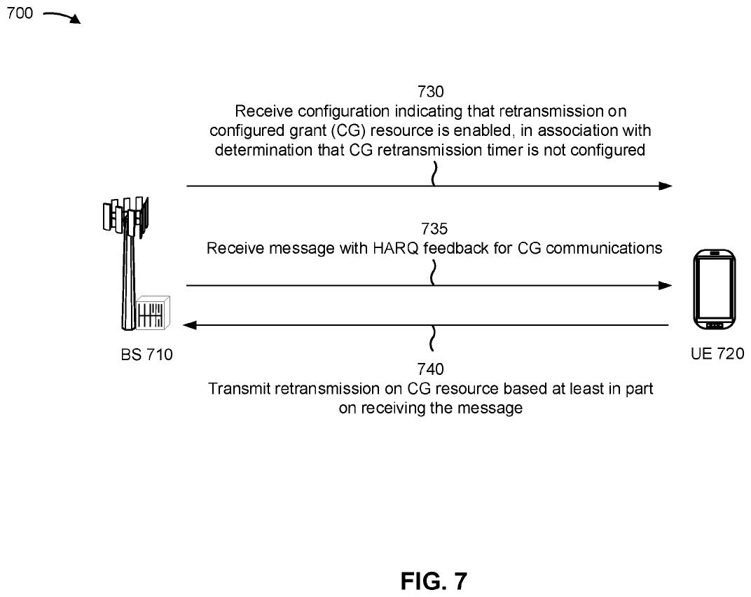

FIG. 7 is a diagram illustrating an example 700 of transmitting retransmissions on a CG resource if a CG retransmission timer is not configured, in accordance with various aspects of the present disclosure. As shown in FIG. 7, example 700 includes communication between a BS 710 and a UE 720. In some aspects, BS 710 and UE 720 may be included in a wireless network, such as wireless network 100. BS 710 and UE 720 may communicate on a wireless access link, which may include an uplink and a downlink. BS 710 may have configured UE 720 for CG.

When a CG retransmission timer is not configured, retransmission on a CG resource is not enabled, and retransmission can only be scheduled by an uplink (UL) grant. Currently, one UL grant can only schedule one communication (e.g., transport block (TB)) for retransmission. For retransmission for multiple TBs, multiple uplink grants are needed. For unlicensed spectrum, multiple LBTs may be needed to transmit multiple uplink grants, which my increase LBT overhead. In some aspects, if retransmission on a CG resource is enabled, a UE may use DFI to indicate HARQ feedback for CG, and one DFI may indicate HARQ feedback for multiple HARQ processes. As a result, LBT overhead is reduced.

As shown by reference number 730, UE 720 may receive a configuration (e.g., in an RRC message) to indicate whether retransmission on a CG resource is enabled, in association with a CG retransmission timer not being configured. If an RRC configuration is provided, retransmission on a CG resource is allowed when the CG retransmission timer is not configured. If the RRC configuration is not provided, retransmission on a CG resource is not allowed when a CG retransmission timer is not configured.

As shown by reference number 735, UE 720 may receive a message with HARQ feedback for one or more uplink CG communications. The message may include DFI. If retransmission on a CG resource is configured, the UE may receive DFI instead of a dynamic grant for retransmission. If a NACK is indicated in the DFI for a HARQ process, the UE may transmit a retransmission for the HARQ process on the CG resource, as shown by reference number 740. A CG timer may be started, and if the CG timer expires, the UE may interpret the expiration as an ACK. The UE may include an NDI in the CG-UCI to distinguish an initial transmission from a retransmission on the CG resource.

As indicated above, FIG. 7 is provided as an example. Other examples may differ from what is described with regard to FIG. 7.

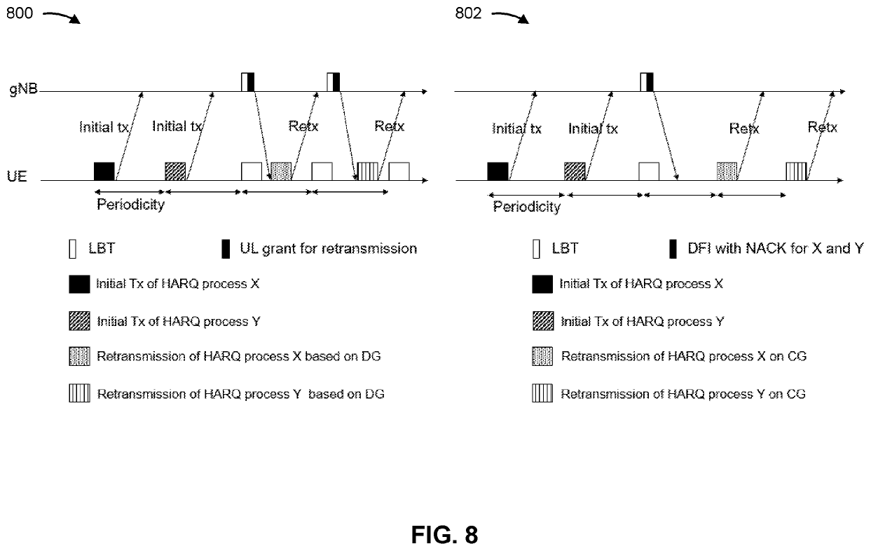

FIG. 8 is a diagram illustrating examples 800, 802 of using a DFI for multiple HARQ processes, in accordance with various aspects of the present disclosure.

Example 800 shows how an uplink grant may be provided for each retransmission. There is an uplink grant for HARQ process X and an uplink grant for HARQ process Y. Example 802 shows how a single DFI may provide for retransmissions for multiple HARQ processes. The single DFI enables retransmission on a CG resource for HARQ process X and retransmission on a CG resource for HARQ process Y.

As indicated above, FIG. 8 provides some examples. Other examples may differ from what is described with regard to FIG. 8.

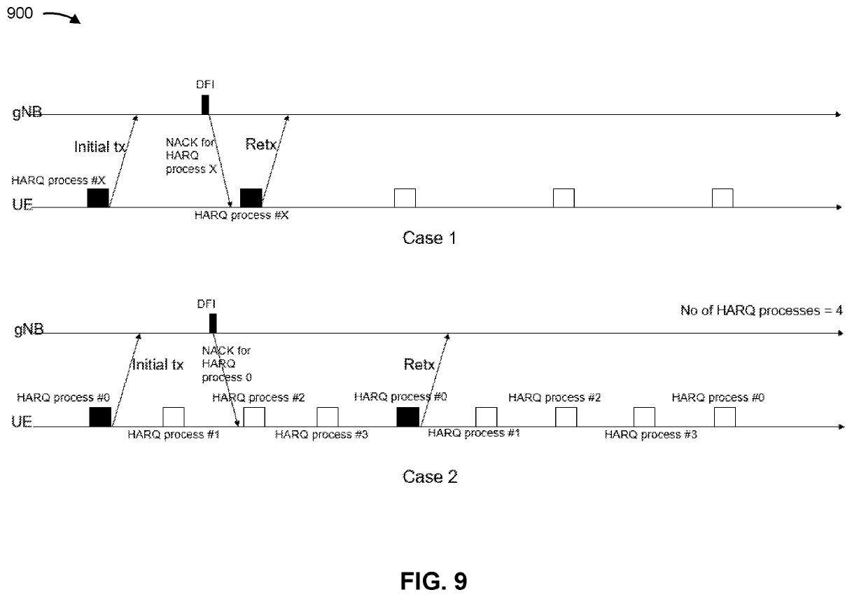

FIG. 9 is a diagram illustrating an example 900 of receiving a NACK in DFI, in accordance with various aspects of the present disclosure.

Example 900 shows a first case (Case 1), where HARQ information may be configured to be included in CG-UCI. With HARQ information in CG-UCI, a HARQ process identifier may be determined by the UE. Retransmissions may be performed on stored CG resources and/or stored modulation and coding schemes after the DFI is received. Retransmissions with the same HARQ process may be performed on any CG configuration if the CG configurations have the same TB size.

Example 900 also shows a second case (Case 2), where HARQ information may be configured to be not included in CG-UCI. Without HARQ information in the CG-UCI, the HARQ process identifier may be calculated based at least in part on an equation related to a CG transmission occasion in a time domain. Retransmissions may be performed on the CG resource with the same HARQ process ID after DFI reception.

As indicated above, FIG. 9 is provided as an example. Other examples may differ from what is described with regard to FIG. 9.

FIG. 10 is a diagram illustrating an example process 1000 performed, for example, by a UE, in accordance with various aspects of the present disclosure. Example process 1000 is an example where the UE (e.g., UE 120 depicted in FIGS. 1-2, the UE depicted in FIG. 3, UE 420 depicted in FIG. 4) performs operations associated with transmitting CG uplink control information if a CG retransmission timer is not configured.

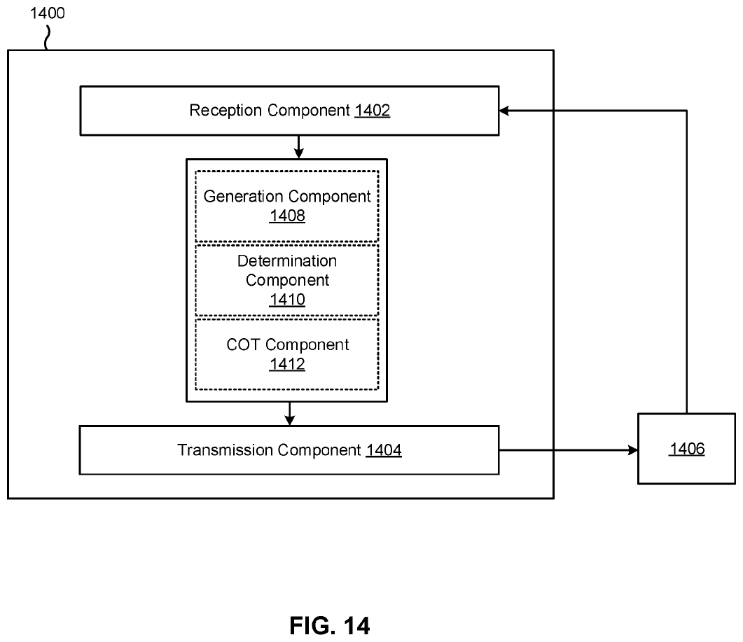

As shown in FIG. 10, in some aspects, process 1000 may include generating CG-UCI based at least in part on a determination that a CG retransmission timer is not configured (block 1010). For example, the UE (e.g., using generation component 1408 depicted in FIG. 14) may generate CG-UCI based at least in part on a determination that a CG retransmission timer is not configured, as described above.

As further shown in FIG. 10, in some aspects, process 1000 may include transmitting the CG-UCI on a physical uplink channel to a base station (block 1020). For example, the UE (e.g., using transmission component 1404 depicted in FIG. 14) may transmit the CG-UCI on a physical uplink channel to a base station, as described above.

Process 1000 may include additional aspects, such as any single aspect or any combination of aspects described below and/or in connection with one or more other processes described elsewhere herein.

In a first aspect, process 1000 includes receiving an uplink grant for a retransmission based at least in part on transmitting the CG-UCI and transmitting the retransmission after receiving the uplink grant for the retransmission.

In a second aspect, alone or in combination with the first aspect, the CG-UCI includes one or more of a HARQ process identifier, an RV identifier, or NDI.

In a third aspect, alone or in combination with one or more of the first and second aspects, process 1000 includes determining one or more of the HARQ process identifier or the RV identifier.

In a fourth aspect, alone or in combination with one or more of the first through third aspects, the CG-UCI includes COT sharing information that indicates whether the base station is able to share a COT of the UE.

In a fifth aspect, alone or in combination with one or more of the first through fourth aspects, process 1000 includes determining that the COT sharing information indicates that the base station is able to share the COT based at least in part on a determination that energy detected in a channel satisfies one or more energy detection thresholds.

In a sixth aspect, alone or in combination with one or more of the first through fifth aspects, the one or more energy detection thresholds include an energy detection threshold that corresponds to a transmission power of the base station and an energy detection threshold that corresponds to a transmission power of the UE.

In a seventh aspect, alone or in combination with one or more of the first through sixth aspects, the COT sharing information indicates a restriction on downlink transmission power.

In an eighth aspect, alone or in combination with one or more of the first through seventh aspects, process 1000 includes sharing the COT to the base station.

In a ninth aspect, alone or in combination with one or more of the first through eighth aspects, the CG-UCI includes a BSR.

In a tenth aspect, alone or in combination with one or more of the first through ninth aspects, the BSR indicates a type of BSR.

In an eleventh aspect, alone or in combination with one or more of the first through tenth aspects, the BSR indicates a buffer size via one or more of logical channel identifier bits or buffer size bits.

In a twelfth aspect, alone or in combination with one or more of the first through eleventh aspects, the BSR indicates a buffer size via a quantity of buffer size bits and via logical channel identifier bits, where the quantity of buffer size bits is based at least in part on a quantity of entries in a table.

In a thirteenth aspect, alone or in combination with one or more of the first through twelfth aspects, the CG-UCI is configured based at least in part on configuration information received in a radio resource control message.

Although FIG. 10 shows example blocks of process 1000, in some aspects, process 1000 may include additional blocks, fewer blocks, different blocks, or differently arranged blocks than those depicted in FIG. 10. Additionally, or alternatively, two or more of the blocks of process 1000 may be performed in parallel.

FIG. 11 is a diagram illustrating an example process 1100 performed, for example, by a base station, in accordance with various aspects of the present disclosure. Example process 1100 is an example where the base station (e.g., base station 110 depicted in FIGS. 1-2, the base station depicted in FIG. 3, BS 410 depicted in FIG. 4) performs operations associated with transmitting CG uplink control information if a CG retransmission timer is not configured.

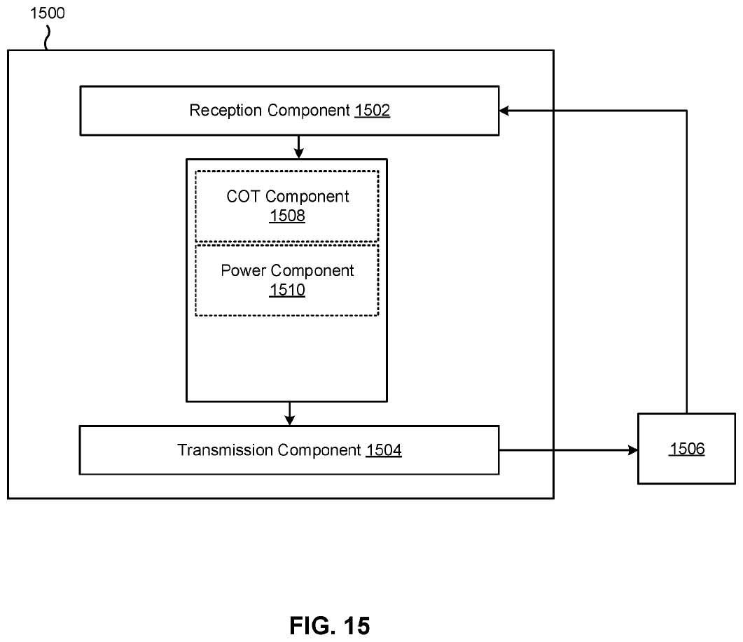

As shown in FIG. 11, in some aspects, process 1100 may include receiving, from a UE, CG-UCI that is associated with a CG retransmission timer not being configured at the UE (block 1110). For example, the base station (e.g., using reception component 1502 depicted in FIG. 15) may receive, from a UE, CG-UCI that is associated with a CG retransmission timer not being configured at the UE, as described above.

As further shown in FIG. 11, in some aspects, process 1100 may include transmitting an uplink grant, to the UE, that is based at least in part on the CG-UCI (block 1120). For example, the base station (e.g., using transmission component 1504 depicted in FIG. 15) may transmit an uplink grant, to the UE, that is based at least in part on the CG-UCI, as described above.

Process 1100 may include additional aspects, such as any single aspect or any combination of aspects described below and/or in connection with one or more other processes described elsewhere herein.

In a first aspect, the CG-UCI includes one or more of a HARQ process identifier, an RV identifier, or an NDI.

In a second aspect, alone or in combination with the first aspect, the CG-UCI includes COT sharing information that indicates whether the base station is to share a COT of the UE.

In a third aspect, alone or in combination with one or more of the first and second aspects, process 1100 includes sharing the COT based at least in part on the COT sharing information.

In a fourth aspect, alone or in combination with one or more of the first through third aspects, process 1100 includes restricting downlink transmission power in the COT based at least in part on the CG-UCI.

In a fifth aspect, alone or in combination with one or more of the first through fourth aspects, the CG-UCI includes a BSR.

In a sixth aspect, alone or in combination with one or more of the first through fifth aspects, the BSR indicates a type of BSR.

In a seventh aspect, alone or in combination with one or more of the first through sixth aspects, the BSR indicates a buffer size via one or more of logical channel identifier bits or buffer size bits.

In an eighth aspect, alone or in combination with one or more of the first through seventh aspects, the BSR indicates a buffer size via a quantity of buffer size bits and via logical channel identifier bits, where the quantity of buffer size bits is based at least in part on a quantity of entries in a table.

In a ninth aspect, alone or in combination with one or more of the first through eighth aspects, process 1100 includes transmitting configuration information for the CG-UCI in a radio resource control message.

In a tenth aspect, alone or in combination with one or more of the first through ninth aspects, the configuration information includes one or more energy detection thresholds associated with COT sharing information.

In an eleventh aspect, alone or in combination with one or more of the first through tenth aspects, process 1100 includes receiving a retransmission after receiving the CG-UCI.

Although FIG. 11 shows example blocks of process 1100, in some aspects, process 1100 may include additional blocks, fewer blocks, different blocks, or differently arranged blocks than those depicted in FIG. 11. Additionally, or alternatively, two or more of the blocks of process 1100 may be performed in parallel.

FIG. 12 is a diagram illustrating an example process 1200 performed, for example, by a UE, in accordance with various aspects of the present disclosure. Example process 1200 is an example where the UE (e.g., UE 120 depicted in FIGS. 1-2, the UE depicted in FIG. 3, UE 720 depicted in FIG. 7) performs operations associated with transmitting retransmissions if a CG retransmission timer is not configured.

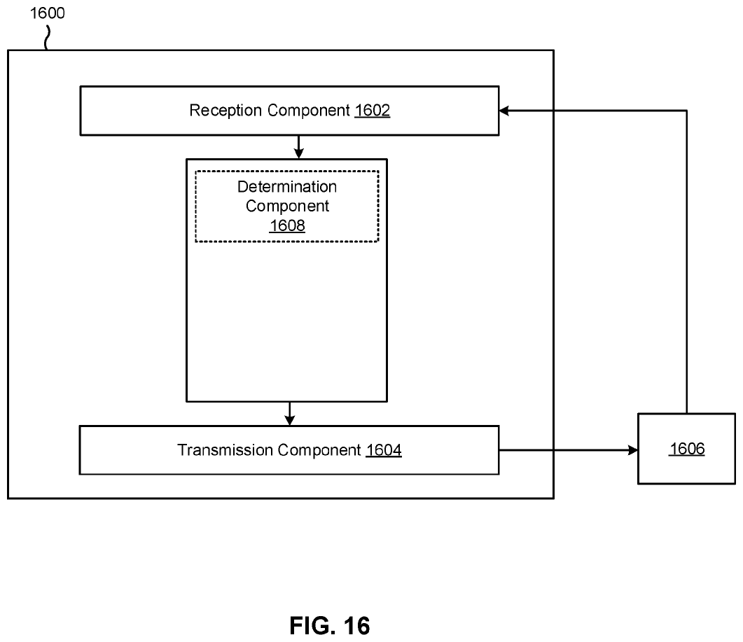

As shown in FIG. 12, in some aspects, process 1200 may include receiving a configuration indicating that retransmission on a CG resource is enabled, in association with a determination that a CG retransmission timer is not configured (block 1210). For example, the UE (e.g., using reception component 1602 depicted in FIG. 16) may receive a configuration indicating that retransmission on a CG resource is enabled, in association with a determination that a CG retransmission timer is not configured, as described above.

As further shown in FIG. 12, in some aspects, process 1200 may include receiving a message that includes HARQ feedback for one or more CG communications (block 1220). For example, the UE (e.g., using reception component 1602 depicted in FIG. 16) may receive a message that includes HARQ feedback for one or more CG communications, as described above.

As further shown in FIG. 12, in some aspects, process 1200 may include transmitting a retransmission on the CG resource based at least in part on receiving the message (block 1230). For example, the UE (e.g., using transmission component 1604 depicted in FIG. 16) may transmit a retransmission on the CG resource based at least in part on receiving the message, as described above.

Process 1200 may include additional aspects, such as any single aspect or any combination of aspects described below and/or in connection with one or more other processes described elsewhere herein.

In a first aspect, the message includes a negative acknowledgment for an uplink transmission.

In a second aspect, alone or in combination with the first aspect, the message includes DFI that is associated with a plurality of HARQ process identifiers.

In a third aspect, alone or in combination with one or more of the first and second aspects, process 1200 includes transmitting one or more of a HARQ process identifier or an RV identifier in CG-UCI based at least in part on a determination that a HARQ process identifier or an RV identifier is to be included in the CG-UCI.

In a fourth aspect, alone or in combination with one or more of the first through third aspects, transmitting the retransmission includes transmitting the retransmission for a HARQ process on the CG resource after receiving downlink feedback information associated with the HARQ process, and where the CG resource is a stored CG resource.

In a fifth aspect, alone or in combination with one or more of the first through fourth aspects, transmitting the retransmission includes transmitting the retransmission for a HARQ process on any CG resource having a same transport block size as indicated in the configuration.

In a sixth aspect, alone or in combination with one or more of the first through fifth aspects, process 1200 includes refraining from transmitting one or more of a HARQ process identifier or an RV identifier in CG-UCI based at least in part on a determination that a HARQ process identifier or an RV identifier is not to be included in the CG-UCI.

In a seventh aspect, alone or in combination with one or more of the first through sixth aspects, transmitting the retransmission includes transmitting the retransmission for a HARQ process on a stored CG resource that is associated with a determined HARQ process identifier after receiving DFI associated with the HARQ process.

In an eighth aspect, alone or in combination with one or more of the first through seventh aspects, process 1200 includes transmitting CG-UCI with a new data indicator based at least in part on whether the CG-UCI is for a retransmission or a new uplink communication.

Although FIG. 12 shows example blocks of process 1200, in some aspects, process 1200 may include additional blocks, fewer blocks, different blocks, or differently arranged blocks than those depicted in FIG. 12. Additionally, or alternatively, two or more of the blocks of process 1200 may be performed in parallel.

FIG. 13 is a diagram illustrating an example process 1300 performed, for example, by a base station, in accordance with various aspects of the present disclosure. Example process 1300 is an example where the base station (e.g., base station 110 depicted in FIGS. 1-2, the base station depicted in FIG. 3, BS 710 depicted in FIG. 7) performs operations associated with transmitting retransmissions if a CG retransmission timer is not configured.

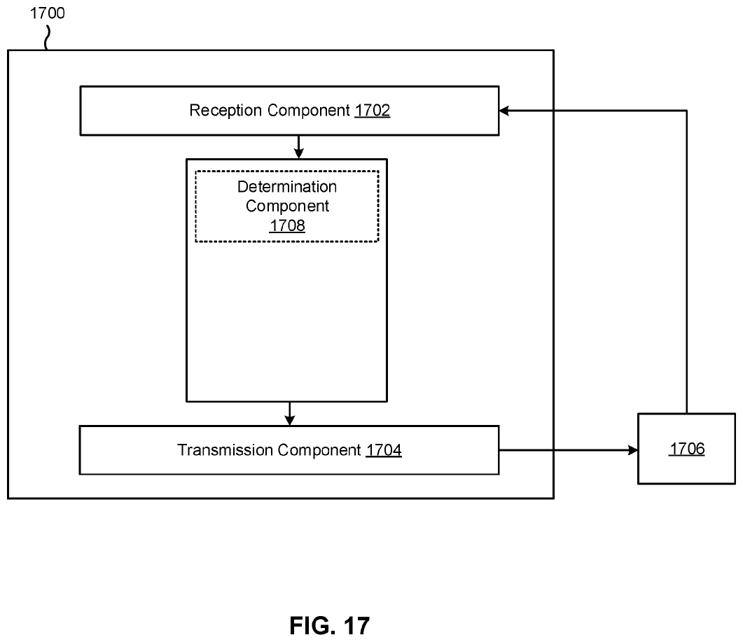

As shown in FIG. 13, in some aspects, process 1300 may include transmitting a configuration, to a UE, indicating that retransmission on a CG resource is enabled, in association with a CG retransmission timer not being configured (block 1310). For example, the base station (e.g., using transmission component 1704 depicted in FIG. 17) may transmit a configuration, to a UE, indicating that retransmission on a CG resource is enabled, in association with a CG retransmission timer not being configured, as described above.

As further shown in FIG. 13, in some aspects, process 1300 may include transmitting a message that includes HARQ feedback of one or more CG communications (block 1320). For example, the base station (e.g., using transmission component 1704 depicted in FIG. 17) may transmit a message that includes HARQ feedback of one or more CG communications, as described above.

As further shown in FIG. 13, in some aspects, process 1300 may include receiving a retransmission on the CG resource based at least in part on transmitting the message (block 1330). For example, the base station (e.g., using reception component 1702 depicted in FIG. 17) may receive a retransmission on the CG resource based at least in part on transmitting the message, as described above.

Process 1300 may include additional aspects, such as any single aspect or any combination of aspects described below and/or in connection with one or more other processes described elsewhere herein.

In a first aspect, the message includes a negative acknowledgment for an uplink transmission.

In a second aspect, alone or in combination with the first aspect, the message includes DFI that is associated with a plurality of HARQ process identifiers.

In a third aspect, alone or in combination with one or more of the first and second aspects, process 1300 includes receiving CG-UCI with an NDI indicating whether the CG-UCI is for a retransmission or a new uplink communication.

Although FIG. 13 shows example blocks of process 1300, in some aspects, process 1300 may include additional blocks, fewer blocks, different blocks, or differently arranged blocks than those depicted in FIG. 13. Additionally, or alternatively, two or more of the blocks of process 1300 may be performed in parallel.

FIG. 14 is a block diagram of an example apparatus 1400 for wireless communication. The apparatus 1400 may be a UE, or a UE may include the apparatus 1400. In some aspects, the apparatus 1400 includes a reception component 1402 and a transmission component 1404, which may be in communication with one another (for example, via one or more buses and/or one or more other components). As shown, the apparatus 1400 may communicate with another apparatus 1406 (such as a UE, a base station, or another wireless communication device) using the reception component 1402 and the transmission component 1404. As further shown, the apparatus 1400 may include a generation component 1408, a determination component 1410, and/or a COT component 1412, among other examples. Each of these components may include a controller/processor, a memory, or a combination thereof, of the UE described above in connection with FIG. 2.

In some aspects, the apparatus 1400 may be configured to perform one or more operations described herein in connection with FIGS. 1-9. Additionally, or alternatively, the apparatus 1400 may be configured to perform one or more processes described herein, such as process 1000 of FIG. 10. In some aspects, the apparatus 1400 and/or one or more components shown in FIG. 14 may include one or more components of the UE described above in connection with FIG. 2. Additionally, or alternatively, one or more components shown in FIG. 14 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1402 may receive communications, such as reference signals, control information, data communications, or a combination thereof, from the apparatus 1406. The reception component 1402 may provide received communications to one or more other components of the apparatus 1400. In some aspects, the reception component 1402 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1406. In some aspects, the reception component 1402 may include one or more antennas, a demodulator, a MIMO detector, a receive processor, a controller/processor, a memory, or a combination thereof, of the UE described above in connection with FIG. 2.

The transmission component 1404 may transmit communications, such as reference signals, control information, data communications, or a combination thereof, to the apparatus 1406. In some aspects, one or more other components of the apparatus 1406 may generate communications and may provide the generated communications to the transmission component 1404 for transmission to the apparatus 1406. In some aspects, the transmission component 1404 may perform signal processing on the generated communications (such as filtering, amplification, modulation, digital-to-analog conversion, multiplexing, interleaving, mapping, or encoding, among other examples), and may transmit the processed signals to the apparatus 1406. In some aspects, the transmission component 1404 may include one or more antennas, a modulator, a transmit MIMO processor, a transmit processor, a controller/processor, a memory, or a combination thereof, of the UE described above in connection with FIG. 2. In some aspects, the transmission component 1404 may be co-located with the reception component 1402 in a transceiver.

The generation component 1408 may generate CG-UCI based at least in part on a determination that a CG retransmission timer is not configured. The transmission component 1404 may transmit the CG-UCI on a physical uplink channel to a base station.

The reception component 1402 may receive an uplink grant for a retransmission based at least in part on transmitting the CG-UCI.

The transmission component 1404 may transmit the retransmission after receiving the uplink grant for the retransmission.

The determination component 1410 may determine one or more of the HARQ process identifier or the RV identifier.

The determination component 1410 may determine that the COT sharing information indicates that the base station is able to share the COT based at least in part on a determination that energy detected in a channel satisfies one or more energy detection thresholds.

The COT component 1412 may share the COT to the base station.

The number and arrangement of components shown in FIG. 14 are provided as an example. In practice, there may be additional components, fewer components, different components, or differently arranged components than those shown in FIG. 14. Furthermore, two or more components shown in FIG. 14 may be implemented within a single component, or a single component shown in FIG. 14 may be implemented as multiple, distributed components. Additionally, or alternatively, a set of (one or more) components shown in FIG. 14 may perform one or more functions described as being performed by another set of components shown in FIG. 14.

FIG. 15 is a block diagram of an example apparatus 1500 for wireless communication. The apparatus 1500 may be a base station, or a base station may include the apparatus 1500. In some aspects, the apparatus 1500 includes a reception component 1502 and a transmission component 1504, which may be in communication with one another (for example, via one or more buses and/or one or more other components). As shown, the apparatus 1500 may communicate with another apparatus 1506 (such as a UE, a base station, or another wireless communication device) using the reception component 1502 and the transmission component 1504. As further shown, the apparatus 1500 may include a COT component 1508 and/or a power component 1510, among other examples. Each of these components may include a controller/processor, a memory, or a combination thereof, of the UE described above in connection with FIG. 2.

In some aspects, the apparatus 1500 may be configured to perform one or more operations described herein in connection with FIGS. 1-9. Additionally, or alternatively, the apparatus 1500 may be configured to perform one or more processes described herein, such as process 1100 of FIG. 11. In some aspects, the apparatus 1500 and/or one or more components shown in FIG. 15 may include one or more components of the base station described above in connection with FIG. 2. Additionally, or alternatively, one or more components shown in FIG. 15 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1502 may receive communications, such as reference signals, control information, data communications, or a combination thereof, from the apparatus 1506. The reception component 1502 may provide received communications to one or more other components of the apparatus 1500. In some aspects, the reception component 1502 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1506. In some aspects, the reception component 1502 may include one or more antennas, a demodulator, a MIMO detector, a receive processor, a controller/processor, a memory, or a combination thereof, of the base station described above in connection with FIG. 2.

The transmission component 1504 may transmit communications, such as reference signals, control information, data communications, or a combination thereof, to the apparatus 1506. In some aspects, one or more other components of the apparatus 1506 may generate communications and may provide the generated communications to the transmission component 1504 for transmission to the apparatus 1506. In some aspects, the transmission component 1504 may perform signal processing on the generated communications (such as filtering, amplification, modulation, digital-to-analog conversion, multiplexing, interleaving, mapping, or encoding, among other examples), and may transmit the processed signals to the apparatus 1506. In some aspects, the transmission component 1504 may include one or more antennas, a modulator, a transmit MIMO processor, a transmit processor, a controller/processor, a memory, or a combination thereof, of the base station described above in connection with FIG. 2. In some aspects, the transmission component 1504 may be co-located with the reception component 1502 in a transceiver.

The reception component 1502 may receive, from a UE, CG-UCI that is associated with a CG retransmission timer not being configured at the UE. The transmission component 1504 may transmit an uplink grant, to the UE, that is based at least in part on the CG-UCI.

The COT component 1508 may share the COT based at least in part on the COT sharing information.

The power component 1510 may restrict downlink transmission power in the COT based at least in part on the CG-UCI.

The transmission component 1504 may transmit configuration information for the CG-UCI in a radio resource control message.

The reception component 1502 may receive a retransmission after receiving the CG-UCI.

The number and arrangement of components shown in FIG. 15 are provided as an example. In practice, there may be additional components, fewer components, different components, or differently arranged components than those shown in FIG. 15. Furthermore, two or more components shown in FIG. 15 may be implemented within a single component, or a single component shown in FIG. 15 may be implemented as multiple, distributed components. Additionally, or alternatively, a set of (one or more) components shown in FIG. 15 may perform one or more functions described as being performed by another set of components shown in FIG. 15.

FIG. 16 is a block diagram of an example apparatus 1600 for wireless communication. The apparatus 1600 may be a UE, or a UE may include the apparatus 1600. In some aspects, the apparatus 1600 includes a reception component 1602 and a transmission component 1604, which may be in communication with one another (for example, via one or more buses and/or one or more other components). As shown, the apparatus 1600 may communicate with another apparatus 1606 (such as a UE, a base station, or another wireless communication device) using the reception component 1602 and the transmission component 1604. As further shown, the apparatus 1600 may include a determination component 1608. Each of these components may include a controller/processor, a memory, or a combination thereof, of the UE described above in connection with FIG. 2.

In some aspects, the apparatus 1600 may be configured to perform one or more operations described herein in connection with FIGS. 1-9. Additionally, or alternatively, the apparatus 1600 may be configured to perform one or more processes described herein, such as process 1200 of FIG. 12. In some aspects, the apparatus 1600 and/or one or more components shown in FIG. 16 may include one or more components of the UE described above in connection with FIG. 2. Additionally, or alternatively, one or more components shown in FIG. 16 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1602 may receive communications, such as reference signals, control information, data communications, or a combination thereof, from the apparatus 1606. The reception component 1602 may provide received communications to one or more other components of the apparatus 1600. In some aspects, the reception component 1602 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1606. In some aspects, the reception component 1602 may include one or more antennas, a demodulator, a MIMO detector, a receive processor, a controller/processor, a memory, or a combination thereof, of the UE described above in connection with FIG. 2.

The transmission component 1604 may transmit communications, such as reference signals, control information, data communications, or a combination thereof, to the apparatus 1606. In some aspects, one or more other components of the apparatus 1606 may generate communications and may provide the generated communications to the transmission component 1604 for transmission to the apparatus 1606. In some aspects, the transmission component 1604 may perform signal processing on the generated communications (such as filtering, amplification, modulation, digital-to-analog conversion, multiplexing, interleaving, mapping, or encoding, among other examples), and may transmit the processed signals to the apparatus 1606. In some aspects, the transmission component 1604 may include one or more antennas, a modulator, a transmit MIMO processor, a transmit processor, a controller/processor, a memory, or a combination thereof, of the UE described above in connection with FIG. 2. In some aspects, the transmission component 1604 may be co-located with the reception component 1602 in a transceiver.

The reception component 1602 may receive a configuration indicating that retransmission on a CG resource is enabled, in association with a determination that a CG retransmission timer is not configured. The reception component 1602 may receive a message that includes hybrid automatic repeat request (HARQ) feedback for one or more CG communications. The transmission component 1604 may transmit a retransmission on the CG resource based at least in part on receiving the message.

The transmission component 1604 may transmit one or more of a HARQ process identifier or an RV identifier in CG-UCI based at least in part on a determination that a HARQ process identifier or an RV identifier is to be included in the CG-UCI.

The determination component 1608 may refrain from transmitting one or more of a HARQ process identifier or an RV identifier in CG-UCI based at least in part on a determination that a HARQ process identifier or an RV identifier is not to be included in the CG-UCI.

The transmission component 1604 may transmit CG-UCI with a new data indicator based at least in part on whether the CG-UCI is for a retransmission or a new uplink communication.

The number and arrangement of components shown in FIG. 16 are provided as an example. In practice, there may be additional components, fewer components, different components, or differently arranged components than those shown in FIG. 16. Furthermore, two or more components shown in FIG. 16 may be implemented within a single component, or a single component shown in FIG. 16 may be implemented as multiple, distributed components. Additionally, or alternatively, a set of (one or more) components shown in FIG. 16 may perform one or more functions described as being performed by another set of components shown in FIG. 16.

FIG. 17 is a block diagram of an example apparatus 1700 for wireless communication. The apparatus 1700 may be a base station, or a base station may include the apparatus 1700. In some aspects, the apparatus 1700 includes a reception component 1702 and a transmission component 1704, which may be in communication with one another (for example, via one or more buses and/or one or more other components). As shown, the apparatus 1700 may communicate with another apparatus 1706 (such as a UE, a base station, or another wireless communication device) using the reception component 1702 and the transmission component 1704. As further shown, the apparatus 1700 may include a determination component 1708, among other examples. The determination component 1708 may include a controller/processor, a memory, or a combination thereof, of the UE described above in connection with FIG. 2.

In some aspects, the apparatus 1700 may be configured to perform one or more operations described herein in connection with FIGS. 1-9. Additionally, or alternatively, the apparatus 1700 may be configured to perform one or more processes described herein, such as process 1300 of FIG. 13. In some aspects, the apparatus 1700 and/or one or more components shown in FIG. 17 may include one or more components of the base station described above in connection with FIG. 2. Additionally, or alternatively, one or more components shown in FIG. 17 may be implemented within one or more components described above in connection with FIG. 2. Additionally, or alternatively, one or more components of the set of components may be implemented at least in part as software stored in a memory. For example, a component (or a portion of a component) may be implemented as instructions or code stored in a non-transitory computer-readable medium and executable by a controller or a processor to perform the functions or operations of the component.

The reception component 1702 may receive communications, such as reference signals, control information, data communications, or a combination thereof, from the apparatus 1706. The reception component 1702 may provide received communications to one or more other components of the apparatus 1700. In some aspects, the reception component 1702 may perform signal processing on the received communications (such as filtering, amplification, demodulation, analog-to-digital conversion, demultiplexing, deinterleaving, de-mapping, equalization, interference cancellation, or decoding, among other examples), and may provide the processed signals to the one or more other components of the apparatus 1706. In some aspects, the reception component 1702 may include one or more antennas, a demodulator, a MIMO detector, a receive processor, a controller/processor, a memory, or a combination thereof, of the base station described above in connection with FIG. 2.

The transmission component 1704 may transmit communications, such as reference signals, control information, data communications, or a combination thereof, to the apparatus 1706. In some aspects, one or more other components of the apparatus 1706 may generate communications and may provide the generated communications to the transmission component 1704 for transmission to the apparatus 1706. In some aspects, the transmission component 1704 may perform signal processing on the generated communications (such as filtering, amplification, modulation, digital-to-analog conversion, multiplexing, interleaving, mapping, or encoding, among other examples), and may transmit the processed signals to the apparatus 1706. In some aspects, the transmission component 1704 may include one or more antennas, a modulator, a transmit MIMO processor, a transmit processor, a controller/processor, a memory, or a combination thereof, of the base station described above in connection with FIG. 2. In some aspects, the transmission component 1704 may be co-located with the reception component 1702 in a transceiver.

The determination component 1708 may determine a configuration for indicating whether the UE is enabled to transmit a retransmission on a CG resource, if CG retransmission is not configured, based at least in part on a UE capability, channel conditions, and/or traffic conditions. The transmission component 1704 may transmit a configuration, to a UE, indicating that retransmission on a CG resource is enabled, in association with a CG retransmission timer not being configured. The transmission component 1704 may transmit a message that includes HARQ feedback of one or more CG communications. The reception component 1702 may receive a retransmission on the CG resource based at least in part on transmitting the message.

The reception component 1702 may receive CG-UCI with an NDI indicating whether the CG-UCI is for a retransmission or a new uplink communication.

The number and arrangement of components shown in FIG. 17 are provided as an example. In practice, there may be additional components, fewer components, different components, or differently arranged components than those shown in FIG. 17. Furthermore, two or more components shown in FIG. 17 may be implemented within a single component, or a single component shown in FIG. 17 may be implemented as multiple, distributed components. Additionally, or alternatively, a set of (one or more) components shown in FIG. 17 may perform one or more functions described as being performed by another set of components shown in FIG. 17.

The foregoing disclosure provides illustration and description, but is not intended to be exhaustive or to limit the aspects to the precise form disclosed. Modifications and variations may be made in light of the above disclosure or may be acquired from practice of the aspects.

As used herein, the term “component” is intended to be broadly construed as hardware, firmware, and/or a combination of hardware and software. As used herein, a processor is implemented in hardware, firmware, and/or a combination of hardware and software. It will be apparent that systems and/or methods described herein may be implemented in different forms of hardware, firmware, and/or a combination of hardware and software. The actual specialized control hardware or software code used to implement these systems and/or methods is not limiting of the aspects. Thus, the operation and behavior of the systems and/or methods were described herein without reference to specific software code—it being understood that software and hardware can be designed to implement the systems and/or methods based, at least in part, on the description herein.

As used herein, satisfying a threshold may, depending on the context, refer to a value being greater than the threshold, greater than or equal to the threshold, less than the threshold, less than or equal to the threshold, equal to the threshold, not equal to the threshold, and/or the like.

Even though particular combinations of features are recited in the claims and/or disclosed in the specification, these combinations are not intended to limit the disclosure of various aspects. In fact, many of these features may be combined in ways not specifically recited in the claims and/or disclosed in the specification. Although each dependent claim listed below may directly depend on only one claim, the disclosure of various aspects includes each dependent claim in combination with every other claim in the claim set. A phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

No element, act, or instruction used herein should be construed as critical or essential unless explicitly described as such. Also, as used herein, the articles “a” and “an” are intended to include one or more items and may be used interchangeably with “one or more.” Further, as used herein, the article “the” is intended to include one or more items referenced in connection with the article “the” and may be used interchangeably with “the one or more.” Furthermore, as used herein, the terms “set” and “group” are intended to include one or more items (e.g., related items, unrelated items, a combination of related and unrelated items, and/or the like), and may be used interchangeably with “one or more.” Where only one item is intended, the phrase “only one” or similar language is used. Also, as used herein, the terms “has,” “have,” “having,” and/or the like are intended to be open-ended terms. Further, the phrase “based on” is intended to mean “based, at least in part, on” unless explicitly stated otherwise. Also, as used herein, the term “or” is intended to be inclusive when used in a series and may be used interchangeably with “and/or,” unless explicitly stated otherwise (e.g., if used in combination with “either” or “only one of”).

1. A method of wireless communication performed by a user equipment (UE), comprising:
generating configured grant uplink control information (CG-UCI) based at least in part on a determination that a configured grant (CG) retransmission timer is not configured; and
transmitting the CG-UCI on a physical uplink channel to a base station.

2. (canceled)

3. The method of claim 1, wherein the CG-UCI includes one or more of a hybrid automatic repeat request (HARD) process identifier, a redundancy version (RV) identifier, or a new data indicator.

4. (canceled)

5. The method of claim 1, wherein the CG-UCI includes channel occupancy time (COT) sharing information that indicates whether the base station is able to share a COT of the UE.

6. The method of claim 5, further comprising determining that the COT sharing information indicates that the base station is able to share the COT based at least in part on a determination that energy detected in a channel satisfies one or more energy detection thresholds.

7. The method of claim 6, wherein the one or more energy detection thresholds include an energy detection threshold that corresponds to a transmission power of the base station and an energy detection threshold that corresponds to a transmission power of the UE.

8. The method of claim 5, wherein the COT sharing information indicates a restriction on downlink transmission power.

9. (canceled)

10. The method of claim 1, wherein the CG-UCI includes a buffer status report (BSR).

11. The method of claim 10, wherein the BSR indicates a type of BSR.

12. The method of claim 10, wherein the BSR indicates a buffer size via one or more of logical channel identifier bits or buffer size bits, or via a quantity of buffer size bits and via logical channel identifier bits, wherein the quantity of buffer size bits is based at least in part on a quantity of entries in a table.

13. (canceled)

14. The method of claim 1, wherein the CG-UCI is configured based at least in part on configuration information received in a radio resource control message.

15.-23. (canceled)

24. A method of wireless communication performed by a user equipment (UE), comprising:
receiving a configuration indicating that retransmission on a configured grant (CG) resource is enabled, in association with a determination that a CG retransmission timer is not configured;
receiving a message that includes hybrid automatic repeat request (HARD) feedback for one or more CG communications; and
transmitting a retransmission on the CG resource based at least in part on receiving the message.

25. The method of claim 24, wherein the message includes a negative acknowledgment for an uplink transmission.

26. The method of claim 24, wherein the message includes downlink feedback information that is associated with a plurality of HARQ process identifiers.

27. The method of claim 24, further comprising transmitting one or more of a HARQ process identifier or a redundancy version (RV) identifier in CG uplink control information (CG-UCI) based at least in part on a determination that a HARQ process identifier or an RV identifier is to be included in the CG-UCI.

28. The method of claim 24, wherein transmitting the retransmission includes transmitting the retransmission for a HARQ process on the CG resource after receiving downlink feedback information associated with the HARQ process, and wherein the CG resource is a stored CG resource.

29. The method of claim 24, wherein transmitting the retransmission includes transmitting the retransmission for a HARQ process on any CG resource having a same transport block size as indicated in the configuration.

30. The method of claim 24, further comprising refraining from transmitting one or more of a HARQ process identifier or a redundancy version (RV) identifier in CG uplink control information (CG-UCI) based at least in part on a determination that a HARQ process identifier or an RV identifier is not to be included in the CG-UCI.

31. The method of claim 30, wherein transmitting the retransmission includes transmitting the retransmission for a HARQ process on a stored CG resource that is associated with a determined HARQ process identifier after receiving downlink feedback information associated with the HARQ process.

32. The method of claim 24, further comprising transmitting CG uplink control information (CG-UCI) with a new data indicator based at least in part on whether the CG-UCI is for a retransmission or a new uplink communication.

33.-34. (canceled)

35. An apparatus for wireless communication, comprising:
means for generating configured grant uplink control information (CG-UCI) based at least in part on a determination that a configured grant (CG) retransmission timer is not configured; and
means for transmitting the CG-UCI on a physical uplink channel to a base station.
